(19) United States
(12) Patent Application Publication
(10) Pub. No.: US 2026/0361623 A1
(43) Pub. Date: Nov. 12, 2026

(54) RESILIENT 5G CELL

(71) Applicant: A10 Systems Inc d/b/a AiRANACULUS, Lowell, MA (US)

(72) Inventors: Apurva N. MODY, Lowell, MA (US); Shyam YADATI, Lowell, MA (US); Zachary GILBERT, Lowell, MA (US); Dap Minh TRAN, Lowell, MA (US); Dibyendu BAKSI, Lowell, MA (US); Bryan CROMPTON, Lowell, MA (US); Daniel GIGER, Lowell, MA (US)

(21) Appl. No.: 19/672,435

(22) Filed: May 8, 2026

Related U.S. Application Data
(60) Provisional application No. 63/802,601, filed on May 9, 2025.

(51) Int. Cl. H04L 41/5009; H04B 1/10; H04B 17/309; H04L 27/36

(52) U.S. Cl. CPC H04L 41/5009; H04B 1/1027; H04B 17/346; H04L 27/364

(57) ABSTRACT

A computer-implemented system mitigates interference in a 5G wireless communication system. An interference detection service receives key performance metric reports for a 5G cell and processes the reports to detect an interference condition. In response, an I/Q acquisition service obtains radio-frequency sample data from a fronthaul mirror, decoded fronthaul traffic, packet captures, or an external software-defined radio. An interference characterization service processes the I/Q data to generate a report identifying spectral characteristics of an interfering signal. Decision logic determines a mitigation command based on the report and cell configuration information. A 5G radio access technology provider translates the mitigation command into reconfiguration commands compatible with a target radio access network implementation. The implementation reconfigures the 5G cell to reduce an effect of the interfering signal.

### CROSS-REFERENCE TO RELATED APPLICATION

This application claims priority to U.S. Provisional Application No. 63/802,301, filed on May 9, 2025, the entire content of which is incorporated herein by reference.

### BACKGROUND

Fifth-generation wireless networks may operate in dense, shared, or contested spectrum. Interference can degrade coverage, capacity, and service quality for a served cell. Conventional responses often require manual diagnosis and coordinated configuration changes. This manual approach can be slow when interference changes over time. Improved techniques are needed for detecting, characterizing, and mitigating interference in 5G radio access networks.

### BRIEF DESCRIPTION OF THE SEVERAL VIEWS OF THE DRAWINGS

The accompanying drawings illustrate selected embodiments of systems and methods for mitigating interference in a 5G wireless communication system. The drawings are provided to aid understanding of the disclosed subject matter. The drawings are not intended to limit the scope of the disclosure.

FIG. 1 illustrates a system architecture for detecting, characterizing, and mitigating interference in 5G radio access network ("RAN") through coordinated sensing, decision-making, and reconfiguration, according to some aspects of the present disclosure.

FIG. 2 illustrates a method flow for mitigating interference in a 5G cell using performance reports, triggered I/Q acquisition, interference characterization, decision logic, and radio access network reconfiguration, according to some aspects of the present disclosure.

FIG. 3A, FIG. 3B illustrates alternative architecture views for resilient mitigation of interference in a wireless deployment using operational telemetry, event-triggered signal characterization, mitigation decision-making, and deployment-compatible reconfiguration, according to some aspects of the present disclosure.

FIG. 4 illustrates a detection and characterization pipeline that processes performance metrics and recovered IQ data to produce interference notifications and characterization reports, according to some aspects of the present disclosure.

FIG. 5 illustrates a mitigation decision-making and reconfiguration architecture that selects a mitigation command and translates the command into coordinated radio access network control actions, according to some aspects of the present disclosure.

FIG. 6 illustrates a user interface view for monitoring and controlling operational state of a resilient 5G deployment, according to some aspects of the present disclosure.

FIG. 7 illustrates an architecture in which interference characterization functions are integrated with 5G radio access network infrastructure and controller-based mitigation functions, according to some aspects of the present disclosure.

FIG. 8 illustrates an architecture in which interference characterization functions are integrated near radio-unit processing resources while controller-based mitigation functions reconfigure a 5G deployment, according to some aspects of the present disclosure.

FIG. 9 illustrates a component view for an interference detection and characterization subsystem that exchanges operational data, acquired signal data, administrative data, and characterization outputs with related system components, according to some aspects of the present disclosure.

FIG. 10 illustrates a component and dataflow view for performance-based interference detection and event generation within a resilient wireless architecture, according to some aspects of the present disclosure.

FIG. 11 illustrates a component and dataflow view for signal-based interference characterization and report generation within a resilient wireless architecture, according to some aspects of the present disclosure.

FIG. 12 illustrates a management-plane command execution architecture for staging and coordinating reconfiguration of radio access network components, according to some aspects of the present disclosure.

FIGS. 13A-13D illustrates signal-analysis views used by an interference characterization process to estimate spectral, temporal, and modulation-related properties of interfering signals, according to some aspects of the present disclosure.

FIG. 14 is a diagram illustrating a computing system according to some aspects of the present disclosure.

### SUMMARY

Aspects of the present disclosure are directed to systems and methods for mitigating interference in a fifth-generation (5G) wireless communication system. In some aspects, key performance metric (KPM) reports associated with operation of a 5G cell are processed to detect an interference condition. In response to detecting the interference condition, in-phase and quadrature (I/Q) data associated with radio-frequency signals in an operating band of the 5G cell is acquired and processed to generate an interference characterization report. Decision logic determines a mitigation command based on the interference characterization report and configuration information for the 5G cell. A 5G radio access technology provider or a radio access translation scheme translates the mitigation command into one or more reconfiguration commands compatible with a 5G radio access network implementation, and the 5G radio access network implementation reconfigures the 5G cell to reduce an effect of the interfering signal.

In one aspect, a computer-implemented method for mitigating interference in a 5G wireless communication system includes receiving, by an interference detection service, key performance metric (KPM) reports associated with operation of a 5G cell; processing the KPM reports to detect an interference condition affecting the 5G cell; in response to detecting the interference condition, initiating acquisition of in-phase and quadrature (I/Q) data associated with radio-frequency signals in an operating band of the 5G cell; processing the I/Q data to generate an interference characterization report indicating at least one spectral characteristic of an interfering signal; determining a mitigation command based on the interference characterization report and configuration information for the 5G cell; translating, using a 5G radio access translation schema, the mitigation command into one or more reconfiguration commands compatible with a 5G radio access network implementation; and causing the 5G radio access network implementation to reconfigure the 5G cell according to the one or more reconfiguration commands to reduce an effect of the interfering signal.

In another aspect, processing the KPM reports includes normalizing the KPM reports into normalized KPM data structures, storing the normalized KPM data structures, organizing the normalized KPM data structures by subscription identifier, discarding centralized-unit data frames, cleaning distributed-unit data frames, extracting relevant distributed-unit features, and evaluating the relevant distributed-unit features to generate an interference event notification.

In another aspect, detecting the interference condition includes applying a neural network or other inference engine trained using KPM data corresponding to non-interference operating conditions and interference operating conditions.

In another aspect, initiating acquisition of the I/Q data includes acquiring the I/Q data from at least one of a mirrored Open Front Haul interface, an evolved Common Public Radio Interface (eCPRI) decoder, packet captures of Open Front Haul traffic, or an external software-defined radio.

In another aspect, the I/Q data is recovered by decoding eCPRI traffic from the mirrored Open Front Haul interface or from the packet captures of Open Front Haul traffic.

In another aspect, the external software-defined radio is controlled by an I/Q collector service that configures at least one of a sampling rate, tuning frequency, or capture parameter for the external software-defined radio.

In another aspect, processing the I/Q data includes segmenting a radio-frequency scene represented by the I/Q data, computing features for resulting I/Q segments, and characterizing the resulting I/Q segments to generate the interference characterization report.

In another aspect, the interference characterization report identifies at least one of a center frequency, bandwidth, spectral location, modulation type, signal type, direction of arrival, narrowband interference, broadband interference, or another 5G signal overlapping the 5G cell.

In another aspect, determining the mitigation command includes determining whether the interfering signal overlaps a center portion or an edge portion of an operating bandwidth of the 5G cell and determining whether alternate spectrum is available for use by the 5G cell.

In another aspect, the mitigation command includes at least one of dynamic bandwidth adaptation, dynamic spectrum access, dynamic channel assignment, dynamic power adaptation, beamforming, beam nulling, scheduling adjustment, resource allocation adjustment, or changing an operating channel of the 5G cell.

In another aspect, translating the mitigation command includes translating a vendor-independent command generated by the decision logic into a vendor-specific or deployment-specific command for a gNB manager, RAN intelligent controller (RIC), rApp, xApp, element management system, or proprietary 5G radio access network interface.

In another aspect, causing the 5G radio access network implementation to reconfigure the 5G cell includes staging a coordinated reconfiguration using a command queue, supervisor, or management-plane component that stops, starts, resets, or rewrites configuration files for one or more of a radio unit, distributed unit, centralized unit, Layer 1 process, or gNB process.

In one aspect, a system for mitigating interference in a 5G wireless communication system includes one or more processors and one or more non-transitory computer-readable storage media storing instructions that, when executed by the one or more processors, cause the system to receive, by an interference detection service, key performance metric (KPM) reports associated with operation of a 5G cell; process the KPM reports to detect an interference condition affecting the 5G cell; in response to detecting the interference condition, initiate acquisition of in-phase and quadrature (I/Q) data associated with radio-frequency signals in an operating band of the 5G cell; process the I/Q data to generate an interference characterization report indicating at least one spectral characteristic of an interfering signal; determine a mitigation command based on the interference characterization report and configuration information for the 5G cell; translate, using a 5G radio access translation schema, the mitigation command into one or more reconfiguration commands compatible with a 5G radio access network implementation; and cause the 5G radio access network implementation to reconfigure the 5G cell according to the one or more reconfiguration commands to reduce an effect of the interfering signal.

In one aspect, a non-transitory computer-readable medium storing instructions that, when executed by one or more processors, cause the one or more processors to perform operations for mitigating interference in a 5G wireless communication system, the operations comprising: receive, by an interference detection service, key performance metric (KPM) reports associated with operation of a 5G cell; process the KPM reports to detect an interference condition affecting the 5G cell; in response to detection of the interference condition, initiate acquisition of in-phase and quadrature (I/Q) data associated with radio-frequency signals in an operating band of the 5G cell; process the I/Q data to generate an interference characterization report indicating at least one spectral characteristic of an interfering signal; determine a mitigation command based on the interference characterization report and configuration information for the 5G cell; translate, using a 5G radio access translation scheme, the mitigation command into one or more reconfiguration commands compatible with a 5G radio access network implementation; and cause the 5G radio access network implementation to reconfigure the 5G cell according to the one or more reconfiguration commands to reduce an effect of the interfering signal.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without departing from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure may be references to the same embodiment or any embodiment; and such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions, will control.

Additional features and advantages of the disclosure will be set forth in the description which follows, and in part will be obvious from the description, or may be learned by practice of the herein disclosed principles. The features and advantages of the disclosure may be realized and obtained by means of the instruments and combinations particularly pointed out in the appended claims. These and other features of the disclosure will become more fully apparent from the following description and appended claims or may be learned by the practice of the principles set forth herein.

The present disclosure relates to resilient operation of a fifth-generation wireless communication system. A 5G cell may be affected by co-channel interference, adjacent-channel interference, congestion, intentional interference, or another radio-frequency condition that reduces network performance. These effects may appear first in operational metrics before an operator can identify the source or location of the interfering signal. Manual diagnosis can require radio-frequency surveys, operator coordination, and delayed reconfiguration of the radio access network. The disclosed technology provides an automated path from metric-based detection to signal characterization and 5G cell reconfiguration.

In some embodiments, an Autonomous Resilient Cell platform, or ARC platform, is a software-defined platform that cooperates with a 5G radio access network. The ARC platform may be implemented using one or more processors and one or more non-transitory computer-readable storage media that store executable instructions. Depending on the 5G deployment, the ARC platform may execute as edge software, as services integrated with radio access network components, as applications associated with a RAN intelligent controller, or as a combination of those deployment forms. The platform may be used with an open radio access network deployment or with a proprietary 5G deployment.

The ARC platform separates detection, characterization, and mitigation decisioning. An Autonomous Interference Detection and Characterization subsystem, or AIDAC subsystem, receives key performance metric reports. Key performance metric reports, or KPM reports, are operational measurements associated with a next generation NodeB ("gNB") or another 5G radio access network component. The AIDAC subsystem processes the KPM reports to determine whether the 5G cell is operating under an interference condition or anomaly. In some embodiments, this detection uses normalized KPM data and a neural network or other inference engine trained using KPM data from non-interference and interference operating conditions.

Detection alone may not provide enough information to select a mitigation action. In response to an interference event, the ARC platform initiates acquisition of in-phase and quadrature data. In-phase and quadrature data, or I/Q data, represents received radio-frequency signal content in a form that can be analyzed for spectral characteristics. The I/Q data may be recovered from a mirrored Open Fronthaul interface. It may be decoded from evolved Common Public Radio Interface traffic, obtained from packet captures of Open Fronthaul traffic, or collected from an external software-defined radio. Regardless of the acquisition source, the downstream characterization pipeline may consume a common recovered I/Q representation.

An interference characterization service processes the recovered I/Q data to generate an interference characterization report. To do so, the service may segment a radio-frequency scene represented by the I/Q data, compute features for the resulting segments, and characterize the segments. The interference characterization report may identify center frequency, bandwidth, spectral location, modulation type, signal type, direction of arrival, narrowband interference, broadband interference, or overlap with another 5G signal. The report may be used with an interference event notification to provide context for mitigation decision logic.

An Autonomous Interference Mitigation Software subsystem, or AIMS subsystem, selects and applies mitigation techniques. The AIMS subsystem may include decision logic that receives an interference event notification, an interference characterization report, cell configuration information, and status feedback from the 5G system. Using that information, the decision logic may determine whether an interfering signal overlaps a center portion or an edge portion of the operating bandwidth. The decision logic may also determine whether alternate spectrum is available. Based on that information, the decision logic may select dynamic bandwidth adaptation, dynamic spectrum access, dynamic channel assignment, dynamic power adaptation, beamforming, beam nulling, scheduling adjustment, resource allocation adjustment, a channel change, or another disclosed reconfiguration action.

The decision logic may generate a mitigation command in a vendor-independent or deployment-independent form. A 5G radio access technology provider, also referred to as a RAT provider, may serve as an adaptation layer that exposes a standardized interface to the decision logic. The RAT provider may also map standardized internal calls to the control interfaces of a particular 5G deployment. This separation allows the decision logic to express a high-level mitigation decision without being rewritten for each radio access network implementation. The RAT provider may translate the mitigation command into reconfiguration commands for a gNB manager, a RAN intelligent controller, an rApp, an xApp, an element management system, or a proprietary 5G radio access network interface.

In some embodiments, a standardized O-RAN reconfiguration interface may be unavailable. In that case, the RAT provider may cooperate with a gNB management front-end and back-end service. The service may expose an internal application programming interface, update gNB configuration files, stop a cell, start the cell, and provide process state information. A command queue, command runner, supervisor component, or management-plane component may stage the reconfiguration. Those staged actions may affect a radio unit, a distributed unit, a centralized unit, a Layer 1 process, a gNB process, or another RAN process involved in operation of the 5G cell.

An Automated Control Service subsystem, or ACSVC subsystem, may provide element management and persistence services. The subsystem may provide configuration management, fault management, performance monitoring, security management, software inventory management, object storage for structured system data, and time-series storage for metrics or logs. In some embodiments, API access in a hybrid edge cloud architecture may be protected using per-user application programming interface keys. When that capability is present in the deployment, requests may be metered and logged.

The disclosed techniques support zero touch operation in which the system detects an interference condition, initiates characterization, recommends or selects mitigation, and applies reconfiguration within seconds to minutes. Through this automated control loop, the system can reduce dependence on manual radio-frequency hunting and manual network reconfiguration. The same architecture can also support a modular feature suite in which resilient cell functions are deployed independently from other radio access network applications.

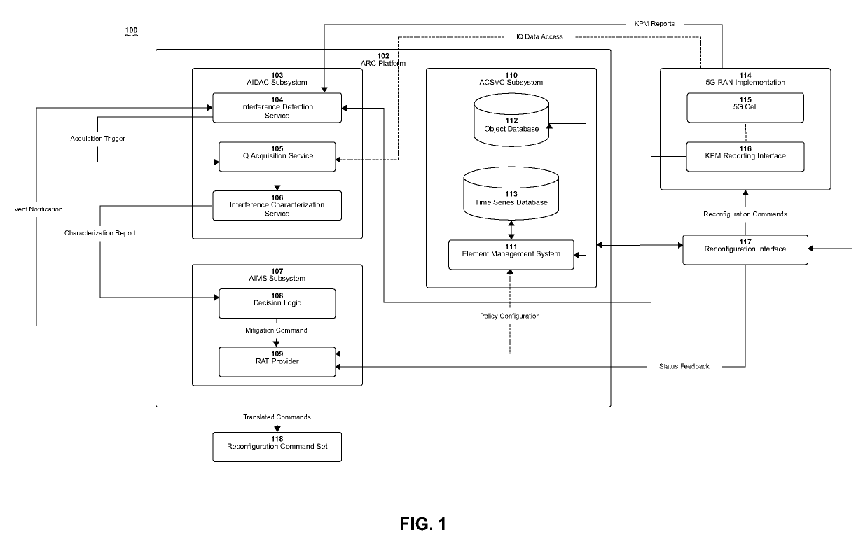

FIG. 1 illustrates a system architecture for detecting, characterizing, and mitigating interference in 5G radio access network ("RAN") through coordinated sensing, decision-making, and reconfiguration, according to some aspects of the present disclosure. System 100 includes Autonomous Resilient Cell ("ARC") Platform 102 coupled to 5G RAN Implementation 114. 5G RAN Implementation 114 serves 5G Cell 115 that may experience interference in its operating band, and ARC Platform 102 receives operational data from 5G RAN Implementation 114 and returns control actions that reconfigure 5G Cell 115.

In the illustrated arrangement, ARC Platform 102 is a software-defined platform that separates interference sensing, interference characterization, mitigation decision-making, and deployment-specific control. This separation allows the same mitigation workflow to be used across different 5G deployments even when the available control interfaces differ. ARC Platform 102 may execute on edge compute resources, on RAN-adjacent compute resources, or on a combination of compute resources associated with the 5G deployment. In some embodiments, one or more functions of ARC Platform 102 are deployed as containerized services. In some embodiments, one or more functions are deployed as xApps, rApps, edge services, or components integrated with a radio unit, a distributed unit, a centralized unit, or associated compute resources. In some embodiments, ARC Platform 102 is deployed in a stand-alone local installation with 5G RAN Implementation 114 and associated site resources. In some embodiments, the deployment also includes a core network, a RAN intelligent controller ("RIC"), and one or more applications deployed locally at the site. In some embodiments, Autonomous Interference Detection and Characterization ("AIDAC") Subsystem 103, Autonomous Interference Mitigation Software ("AIMS") Subsystem 107, and Automated Control Service ("ACSVC") Subsystem 110 are deployed as distinct elements with flexible placement across edge and cloud resources. That modularity allows the interference detection path, the interference characterization path, and the mitigation control path to be scaled or placed according to deployment requirements while preserving the end-to-end workflow shown in FIG. 1.

During operation, AIDAC Subsystem 103 begins the mitigation loop by using lightweight telemetry to determine when deeper signal analysis is warranted. AIDAC Subsystem 103 includes Interference Detection Service 104, in-phase and quadrature ("IQ") Acquisition Service 105, and Interference Characterization Service 106. As shown, Interference Detection Service 104 receives KPM Reports from 5G RAN Implementation 114 through KPM Reporting Interface 116. The KPM Reports are associated with operation of 5G Cell 115 and provide lightweight operational telemetry that can be used to identify a likely interference condition before a more resource-intensive signal capture is invoked. After receipt of the KPM Reports, Interference Detection Service 104 processes the reports to detect an interference condition affecting 5G Cell 115. In some embodiments, Interference Detection Service 104 normalizes the KPM Reports into normalized KPM data structures. The normalized KPM data structures may be stored and organized by subscription identifier so that report streams can be associated with their source context. In some embodiments, centralized-unit data frames are discarded, distributed-unit data frames are cleaned, and relevant distributed-unit features are extracted for evaluation. Detection may then be performed by a neural network or another inference engine trained using KPM data representing non-interference operating conditions and interference operating conditions. When the evaluated KPM data indicates onset of interference or an anomaly, Interference Detection Service 104 issues an Event Notification to AIMS Subsystem 107 and also provides an Acquisition Trigger to IQ Acquisition Service 105.

In response to the detected event, the system shifts from telemetry-based screening to signal capture and characterization. Because detailed radio-frequency capture can consume additional processing and collection resources, IQ Acquisition Service 105 is invoked in response to the detected event rather than as a continuously running capture path. IQ Acquisition Service 105 initiates acquisition of IQ data associated with radio-frequency signals in the operating band of 5G Cell 115. In some embodiments, the IQ data is acquired from a mirrored Open Fronthaul interface. In some embodiments, the IQ data is recovered by decoding evolved Common Public Radio Interface ("eCPRI") traffic or by decoding packet captures associated with Open Fronthaul traffic. In some embodiments, the IQ data is collected from an external software-defined radio ("SDR"). When an external SDR is used, IQ Acquisition Service 105 may control capture settings associated with that radio so that the collected samples correspond to the radio-frequency conditions relevant to the detected event. IQ Data Access shown between 5G RAN Implementation 114 and IQ Acquisition Service 105 indicates that the acquisition path may depend on deployment-specific access to signal-bearing data sources within or adjacent to the RAN implementation.

Once IQ data has been acquired, Interference Characterization Service 106 processes that data to generate a Characterization Report for use in mitigation selection. In some embodiments, Interference Characterization Service 106 segments the radio-frequency scene represented by the IQ data into IQ segments, computes features for the resulting segments, and characterizes the resulting segments using the computed features and associated segment context. The resulting interference characterization report may identify one or more spectral characteristics of an interfering signal. Those characteristics may include a center frequency, bandwidth, spectral location within the operating bandwidth of 5G Cell 115, modulation type, signal type, direction of arrival, or an indication of whether the interference is narrowband, broadband, or caused by another 5G signal overlapping 5G Cell 115. The report may therefore provide more specific signal understanding than is available from KPM-based detection alone. In this way, the architecture uses KPM telemetry for fast event detection and then uses recovered IQ data for deeper characterization when warranted.

After the interference condition has been detected and characterized, AIMS Subsystem 107 selects a mitigation that fits both the signal conditions and the current cell context. Mitigation selection is handled by AIMS Subsystem 107, which includes Decision Logic 108 and radio access technology ("RAT") Provider 109. Decision Logic 108 receives the Characterization Report from Interference Characterization Service 106. Decision Logic 108 may also receive the Event Notification generated from the KPM-based detection stage, configuration information for 5G Cell 115, and Status Feedback returned through RAT Provider 109. Using these inputs together, Decision Logic 108 determines a Mitigation Command that is responsive to the detected interference condition and compatible with the current operating context of 5G Cell 115. Decision Logic 108 may generate the Mitigation Command as a vendor-independent internal decision. That abstraction allows the core decision-making process to remain stable even when the downstream reconfiguration mechanism changes across vendors or deployments. In some embodiments, Decision Logic 108 determines whether the interfering signal overlaps a center portion or an edge portion of the operating bandwidth of 5G Cell 115. In some embodiments, Decision Logic 108 also determines whether alternate spectrum is available for use by 5G Cell 115. Based on that information, the Mitigation Command may specify dynamic bandwidth adaptation, dynamic spectrum access, dynamic channel assignment, dynamic power adaptation, beamforming, beam nulling, scheduling adjustment, resource allocation adjustment, or changing an operating channel of 5G Cell 115. Where the characterized interference overlaps only part of the operating band, the selected mitigation may reduce the effect of the interfering signal without requiring a complete change in cell operation.

The selected mitigation is then translated into control actions that the target deployment can execute. Translation of the vendor-independent decision into deployment-compatible control is performed by RAT Provider 109 or a radio access translation scheme. As shown, Decision Logic 108 provides the Mitigation Command to RAT Provider 109, and RAT Provider 109 returns Status Feedback that can be used by Decision Logic 108 during subsequent mitigation decisions. RAT Provider 109 acts as a wrapper layer that exposes a standardized application programming interface to Decision Logic 108 while mapping internal commands into vendor-specific or deployment-specific control actions. In some embodiments, the translated target is a gNB manager, a RIC, an rApp, an xApp, Element Management System ("EMS") 111, or a proprietary 5G radio access network interface. This translation layer addresses the practical condition that standardized reconfiguration interfaces may be absent, incomplete, or implemented differently across 5G deployments.

To apply the selected mitigation at the radio access network, control actions produced by RAT Provider 109 are expressed as Reconfiguration Command Set 118 and delivered toward 5G RAN Implementation 114 through Reconfiguration Interface 117. Reconfiguration Command Set 118 represents one or more reconfiguration commands that are compatible with the target 5G deployment. In some embodiments, the commands are vendor-specific or deployment-specific realizations of the vendor-independent Mitigation Command selected by Decision Logic 108. Reconfiguration Interface 117 then causes 5G RAN Implementation 114 to reconfigure 5G Cell 115 so as to reduce the effect of the interfering signal. The resulting reconfiguration may affect operating frequency, bandwidth, power, beam behavior, scheduling behavior, resource allocation, or related configuration state of 5G Cell 115. In some embodiments, the reconfiguration path uses a management-plane service when a standardized interface is unavailable or unsuitable for the target deployment. In that arrangement, translation performed by RAT Provider 109 may invoke a gNB management front end and back end layer that stages and executes Reconfiguration Command Set 118. The management-plane layer may carry out coordinated lifecycle operations for one or more RAN components by updating configuration files, stopping processes, starting processes, resetting processes, or otherwise controlling operation of a radio unit, a distributed unit, a centralized unit, a Layer 1 process, or a gNB process. This allows the architecture to apply mitigation across heterogeneous 5G environments without requiring Decision Logic 108 to be rewritten for each vendor stack.

As the mitigation loop continues, the architecture also supports management, persistence, and feedback-driven adaptation. ACSVC Subsystem 110 includes EMS 111, Object Database 112, and Time Series Database 113. EMS 111 may provide configuration management, fault management, performance monitoring, and security management for elements of ARC Platform 102, including AIDAC and AIMS components. Object Database 112 may persist structured data representing system components, cell configurations, relationships among platform elements, and deployment context used by the mitigation workflow. Time Series Database 113 may persist time-stamped metrics, logs, and operational history associated with 5G Cell 115 and with operation of ARC Platform 102. This stored information may support policy configuration, operational visibility, and subsequent mitigation decisions. As shown by the Status Feedback path, RAT Provider 109 may obtain process state information, cell state information, or reconfiguration outcome information from 5G RAN Implementation 114 and return that information to Decision Logic 108. Decision Logic 108 may use that returned status when selecting a later mitigation action, when determining whether a prior action should be maintained or changed, or when avoiding a control action that is not available in the current deployment state. The architecture therefore supports not only initial mitigation selection but also continued operation of 5G Cell 115 after a reconfiguration has been applied.

Accordingly, FIG. 1 shows an automated interference mitigation loop in which KPM Reports from 5G RAN Implementation 114 are processed by Interference Detection Service 104 to identify an interference condition, IQ Acquisition Service 105 acquires IQ data in response to that condition, Interference Characterization Service 106 generates a Characterization Report indicating spectral characteristics of the interfering signal, Decision Logic 108 selects a vendor-independent Mitigation Command based on the Characterization Report and cell context, RAT Provider 109 translates that command into deployment-compatible reconfiguration actions, and 5G RAN Implementation 114 reconfigures 5G Cell 115 through Reconfiguration Interface 117 and Reconfiguration Command Set 118 to reduce the effect of the interfering signal.

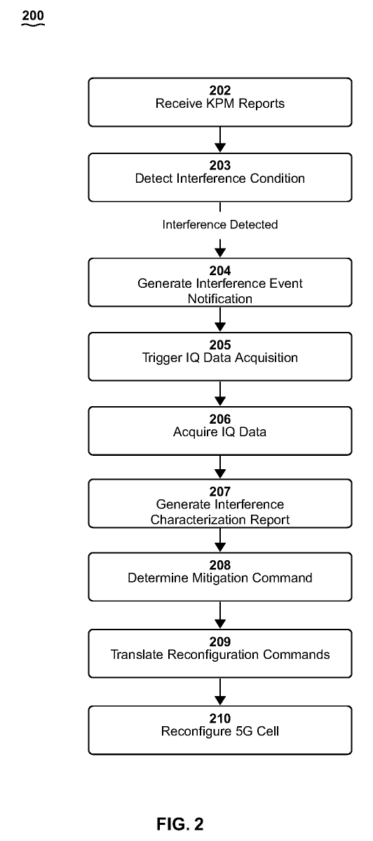

FIG. 2 illustrates a method flow for mitigating interference in a 5G cell using performance reports, triggered I/Q acquisition, interference characterization, decision logic, and radio access network reconfiguration, according to some aspects of the present disclosure. The illustrated method 200 may be performed by the ARC Platform 102 described with respect to FIG. 1. The method 200 may be implemented by one or more services executed by one or more processors and may be stored as instructions on one or more non-transitory computer-readable storage media. In use, the method 200 forms a control loop that detects an interference condition from operational behavior of the 5G cell, obtains signal-level observability for the affected operating band, and applies a deployment-compatible mitigation action to reduce the effect of the interfering signal.

During operation of the 5G cell, operation 202 receives KPM reports associated with operation of the 5G cell from the 5G radio access network while the cell is carrying traffic. As a result, the reports may reflect actual operating conditions rather than a separate test condition. The reports may include measurements that indicate link quality, scheduling behavior, resource use, protocol behavior, physical layer behavior, or a combination thereof. Because vendor interfaces may expose different report formats, the received KPM reports may first be converted into normalized KPM data structures so that later detection processing can operate on a consistent internal representation. Operation 203 then detects an interference condition affecting the 5G cell from those normalized KPM data structures. In some embodiments, this detection processing includes storing the normalized KPM data structures, organizing them by subscription identifier, separating centralized-unit information from distributed-unit information, discarding centralized-unit data frames, cleaning distributed-unit data frames, and extracting relevant distributed-unit features for inference. The extracted features may then be evaluated by a neural network or another inference engine trained using KPM data associated with interference operating conditions and non-interference operating conditions. This stage supports rapid identification of an onset of interference from network behavior alone, which can be useful when direct radio-frequency observability is not continuously available.

When the interference condition is detected, operation 204 generates an interference event notification that may identify the affected 5G cell and may carry context derived from the KPM processing that caused the detection. In this way, the interference event notification acts as a trigger for deeper characterization rather than as the final basis for mitigation. The event notification can therefore separate a near-real-time detection path from a more detailed signal-analysis path. In response to the interference event notification, operation 205 triggers I/Q data acquisition. This triggered approach reduces the need to perform continuous full-band signal capture when no interference condition has been detected. The trigger may identify the cell to be examined, the operating band to be observed, and the data collection interval used for the responsive capture. In some embodiments, the trigger is issued by a service associated with interference acquisition and analysis so that subsequent signal collection is aligned to the detected event.

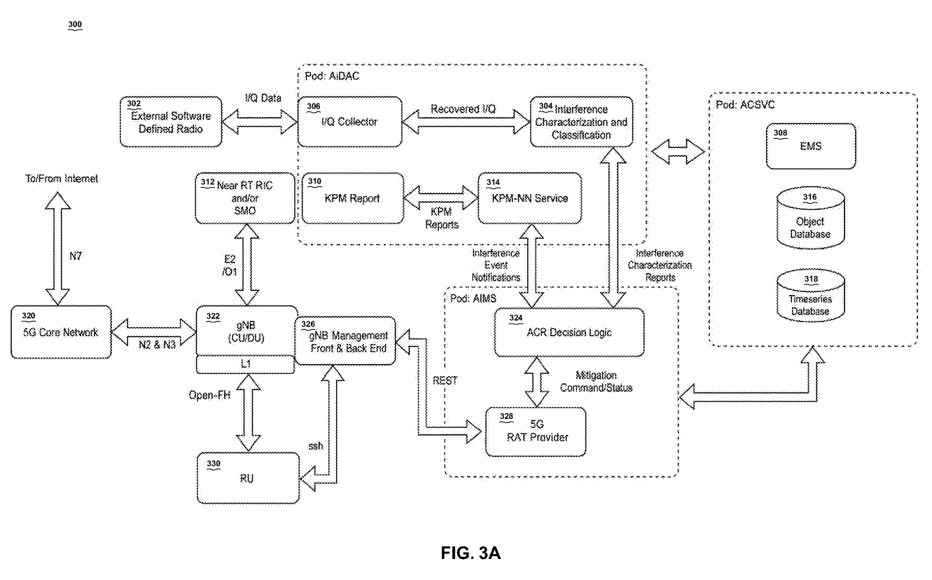

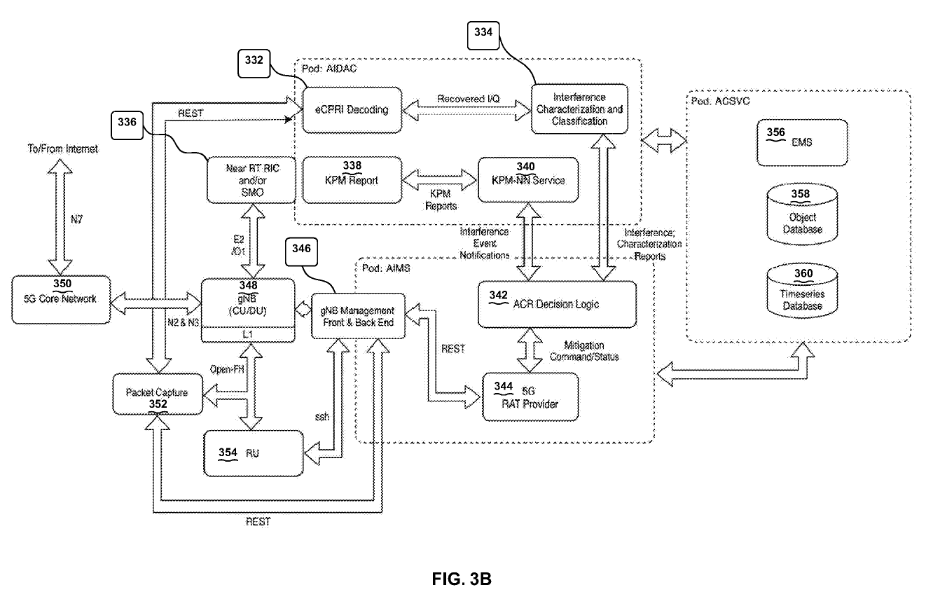

After the trigger is issued, operation 206 acquires I/Q data associated with radio-frequency signals in the operating band of the 5G cell. As described further with respect to FIG. 3B, the I/Q data may be obtained from a mirrored Open Front Haul interface, from an evolved Common Public Radio Interface decoder, from packet captures of Open Front Haul traffic, or from an external software-defined radio. When front-haul traffic is used, the I/Q data may be recovered by decoding evolved Common Public Radio Interface traffic from the mirrored Open Front Haul interface or from the packet captures. When an external software-defined radio is used, an I/Q collector service may control capture settings for that device so that the collected data corresponds to the operating band of interest. By allowing multiple acquisition paths, the method 200 can preserve interference observability across deployments in which available vendor interfaces differ. Once the I/Q data has been acquired, operation 207 generates an interference characterization report. In some embodiments, the acquired or recovered I/Q data represents a radio-frequency scene that is segmented into I/Q segments, and features are computed for the resulting segments before characterization is performed. The resulting report indicates at least one spectral characteristic of an interfering signal and may further identify a center frequency, bandwidth, spectral location, modulation type, signal type, direction of arrival, narrowband interference, broadband interference, or overlap with another 5G signal. This report gives the decision logic a signal-aware description of the interference condition, rather than relying only on performance degradation indicators from the KPM reports.

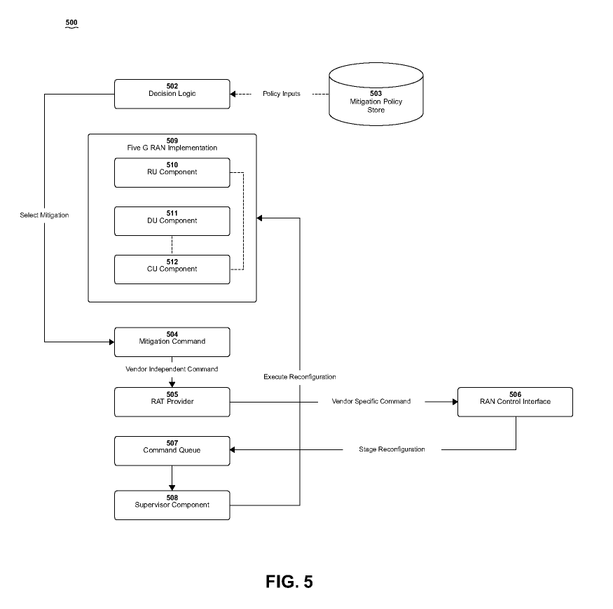

Using that signal-aware description, operation 208 determines a mitigation command based on the interference characterization report. The decision logic may evaluate the interference characterization report together with configuration information for the 5G cell so that the selected action is responsive to both the observed interference and the current operating state of the cell. In some embodiments, the decision logic determines whether the interfering signal overlaps a center portion or an edge portion of the operating bandwidth of the 5G cell and also determines whether alternate spectrum is available for use by the 5G cell. Using that information, the mitigation command may specify dynamic bandwidth adaptation, dynamic spectrum access, dynamic channel assignment, dynamic power adaptation, beamforming, beam nulling, scheduling adjustment, resource allocation adjustment, or changing an operating channel of the 5G cell. This decision stage allows the system to choose an action that reduces the effect of the interfering signal while remaining tied to the actual configuration options of the deployment. At operation 209, the 5G radio access technology provider translates the mitigation command into one or more reconfiguration commands compatible with a 5G radio access network implementation. The mitigation command may be produced by the decision logic in a vendor-independent form, and the translation stage maps that form into deployment-specific control actions. In some embodiments, the translated commands are compatible with a gNB manager, a RAN intelligent controller, an rApp, an xApp, an element management system, or a proprietary 5G radio access network interface. As described further with respect to FIG. 5, this translation layer allows the decision logic to remain focused on interference mitigation policy while the 5G radio access technology provider handles implementation-specific control details.

The translated reconfiguration commands are applied at operation 210 to reconfigure the 5G cell and reduce the effect of the interfering signal. The reconfiguration may adjust bandwidth, spectrum use, channel assignment, power, beam behavior, scheduling behavior, resource allocation, or a combination thereof, depending on the selected mitigation command and the capabilities of the target deployment. In some embodiments, the reconfiguration is staged through a command queue, supervisor, or management-plane component so that multiple lifecycle actions can be coordinated in the order required by the 5G radio access network implementation. The coordinated reconfiguration may include stopping, starting, resetting, or rewriting configuration files for one or more of a radio unit, distributed unit, centralized unit, Layer 1 process, or gNB process. Viewed as a whole, the method 200 supports a resilient operating mode for the 5G cell. KPM-based detection provides a fast indication that interference is likely present. Triggered I/Q acquisition and characterization then provide a more detailed understanding of the interfering signal. The mitigation command is selected from that characterization and translated into deployment-compatible reconfiguration actions, so that the control loop can move from detection to applied mitigation without requiring the decision logic to be rewritten for each radio access network implementation. In some embodiments, the detection portion operates in near real time, while the resulting mitigation is applied within seconds to minutes, depending on the responsiveness of the deployment and the reconfiguration path that is available.

FIG. 3A, FIG. 3B illustrates alternative architecture views for resilient mitigation of interference in a wireless deployment using operational telemetry, event-triggered signal characterization, mitigation decision-making, and deployment-compatible reconfiguration, according to some aspects of the present disclosure.

FIG. 3A shows architecture 300 as one non-limiting deployment of a resilient 5G cell platform arranged around a closed control loop. That loop observes operation of a 5G cell, detects an interference condition, characterizes a radio-frequency environment associated with that condition, selects a mitigation response, and causes reconfiguration through a control path available in the target deployment. The figure groups functions into Pod: AiDAC, Pod: AIMS, and Pod: ACSVC. This grouping reflects a modular implementation rather than a required physical partition. In some embodiments, these pods execute on edge compute resources located near the radio access network. In some embodiments, one or more of the pods execute on cloud resources, site-local resources, or a combination of those resources while preserving the same logical interactions.

The managed radio access network is illustrated by 5G Core Network 320, gNB (CU/DU) 322, and RU 330 during observation of the served cell. 5G Core Network 320 exchanges N2 & N3 traffic with gNB (CU/DU) 322 and communicates To/From Internet through the N7 path shown in the figure. gNB (CU/DU) 322 includes an L1 portion and exchanges Open-FH traffic with RU 330. RU 330 represents the radio unit portion of the served 5G cell. Together, these elements provide the operational environment from which telemetry is obtained and to which mitigation actions are ultimately applied. As a result, the same architecture supports both observation of the 5G cell and reconfiguration of that same cell.

As the control loop monitors operation, one input is operational telemetry and another input is signal-domain information. KPM Report 310 in Pod: AiDAC represents key performance metric reporting associated with operation of the 5G cell. Near RT RIC and/or SMO 312 is positioned between the resilient platform and gNB (CU/DU) 322, and the E2 /O1 path indicates that telemetry exchange, management exchange, or both may occur through standardized O-RAN related interfaces when such interfaces are implemented in the deployment. This reflects the practical reality that heterogeneous 5G deployments do not provide identical telemetry and reconfiguration support. The platform therefore accepts telemetry through standardized controller paths when available, while keeping higher-level detection and mitigation logic separate from any one controller implementation. In some embodiments, telemetry used by KPM Report 310 is obtained through a near-real-time controller using an E2-related interface. In some embodiments, telemetry is obtained through a vendor-exposed metrics feed or another reporting path exposed by the deployment.

When telemetry indicates degraded behavior, KPM-NN Service 314 receives KPM Reports from KPM Report 310 and evaluates those reports to detect interference or anomaly onset. In some embodiments, KPM-NN Service 314 normalizes incoming reports into normalized KPM data structures and stores those data structures. It can organize them by subscription identifier, discard centralized-unit data frames, clean distributed-unit data frames, extract relevant distributed-unit features, and evaluate those features to generate an interference event notification. In some embodiments, the evaluation is performed by a neural network or other inference engine trained using KPM data corresponding to interference and non-interference operating conditions. The illustrated Interference Event Notifications path from KPM-NN Service 314 to ACR Decision Logic 324 shows that the detection result is forwarded as a machine-usable trigger rather than merely as a human-facing alert. In some embodiments, that trigger also initiates capture or further processing of I/Q data so that signal characterization follows detection of degraded cell behavior.

In response to such a trigger, Pod: AiDAC can obtain radio-frequency evidence through External Software Defined Radio 302 and I/Q Collector 306. Within Pod: AiDAC, External Software Defined Radio 302 is coupled to I/Q Collector 306 through an I/Q Data path. I/Q Collector 306 acquires or supervises acquisition of in-phase and quadrature data associated with radio-frequency signals in an operating band of the served 5G cell. Because interference may not be fully visible from performance counters alone, I/Q Collector 306 gives the platform access to signal-domain information that can reveal the spectral location and nature of an interfering transmission. In some embodiments, I/Q Collector 306 controls operating parameters of External Software Defined Radio 302 so that a capture aligns with the band, time interval, and measurement conditions relevant to an interference event under investigation. I/Q Collector 306 provides Recovered I/Q to Interference Characterization and Classification 304.

After the Recovered I/Q is available, Interference Characterization and Classification 304 processes the recovered signal data and produces Interference Characterization Reports for use by downstream mitigation logic. In some embodiments, Interference Characterization and Classification 304 segments a radio-frequency scene represented by the recovered I/Q data. It computes features for the resulting I/Q segments and characterizes the segments based on those features and associated segment context. The resulting report may indicate one or more spectral characteristics of an interfering signal. Those characteristics may include a frequency location within the operating spectrum, a bandwidth, a modulation-related characteristic, a signal type, a direction-related characteristic, or an indication that the interfering signal overlaps a 5G signal used by the affected cell. The same processing may also classify the interference as narrowband interference, broadband interference, or interference associated with another 5G signal. This characterization gives ACR Decision Logic 324 a basis for choosing a response that is tied to the actual interference mechanism rather than to a generic alarm.

Once both operational evidence and signal-domain evidence are available, Pod: AIMS uses them to select a response that matches the deployment context. Pod: AIMS contains ACR Decision Logic 324 and 5G RAT Provider 328. ACR Decision Logic 324 receives Interference Event Notifications from KPM-NN Service 314 and Interference Characterization Reports from Interference Characterization and Classification 304. By combining operational evidence from KPM analysis with signal-domain evidence from recovered I/Q data, ACR Decision Logic 324 can distinguish whether a performance degradation is consistent with interference and can select a mitigation technique that matches the characterized interference. In some embodiments, ACR Decision Logic 324 uses configuration information for the affected 5G cell when determining a mitigation command. In some embodiments, ACR Decision Logic 324 also uses status information returned after attempted mitigation so that later decisions account for the present operating state of the deployment. This arrangement supports resilient operation because the decision logic is informed by both what the cell is experiencing and what the deployment can accept as a valid reconfiguration.

The mitigation decision generated by ACR Decision Logic 324 may correspond to dynamic bandwidth adaptation, dynamic spectrum access, dynamic channel assignment, dynamic power adaptation, beamforming, beam nulling, scheduling adjustment, resource allocation adjustment, or a change in operating channel. In some embodiments, ACR Decision Logic 324 determines whether the interfering signal overlaps a center portion or an edge portion of the operating bandwidth of the 5G cell. In some embodiments, ACR Decision Logic 324 also determines whether alternate spectrum is available for use by that cell. A signal that intrudes at an edge of the operating band may support a different mitigation choice than a signal that overlaps a central portion of the cell bandwidth. Likewise, availability of alternate spectrum may support a channel change, while lack of alternate spectrum may support a narrower or otherwise adapted operating configuration. The output of ACR Decision Logic 324 is therefore a mitigation command expressed at a level that captures the selected operational outcome without requiring the decision logic to encode vendor-specific control details.

To carry that mitigation into the target radio access implementation, 5G RAT Provider 328 exchanges Mitigation Command/Status information with ACR Decision Logic 324. 5G RAT Provider 328 operates as a radio access translation scheme. It maps a vendor-independent or deployment-independent mitigation command into one or more reconfiguration commands compatible with the target 5G radio access network implementation. This separation addresses a common deployment problem. Higher-level interference logic should remain portable across different 5G vendor stacks, while execution of a reconfiguration often depends on deployment-specific interfaces and lifecycle procedures. Accordingly, 5G RAT Provider 328 exposes a common internal command format upstream and performs deployment-specific translation downstream. In some embodiments, the same ACR Decision Logic 324 is reused across different 5G vendor deployments, while provider-specific behavior is confined to 5G RAT Provider 328.

Execution of the translated response can proceed through whichever management path is available in the deployment. The figure shows a REST path between 5G RAT Provider 328 and gNB Management Front & Back End 326. Through that path, gNB Management Front & Back End 326 provides a management-plane execution path that can apply translated mitigation commands to the radio access deployment even when a standardized reconfiguration interface is absent, incomplete, or implemented differently across vendors. In some embodiments, 5G RAT Provider 328 communicates instead with a non-real-time RIC, an rApp, or another O1-related management interface when such an interface is implemented and supports the needed reconfiguration. In some embodiments, the architecture omits one or more RIC components and interfaces directly with vendor-specific management components associated with gNB (CU/DU) 322, RU 330, or the L1 portion of the deployment. The figure thus shows that the platform is not limited to a single control-plane style.

When mitigation requires coordinated lifecycle activity, gNB Management Front & Back End 326 is positioned adjacent to gNB (CU/DU) 322 and is also coupled to RU 330 through a path labeled ssh. That arrangement indicates that deployment-specific execution may include direct interaction with managed processes or managed elements in the radio unit and baseband portions of the cell. In some embodiments, gNB Management Front & Back End 326 stages a coordinated reconfiguration after receiving a translated request, converting that request into a deployment-specific sequence, and applying that sequence to one or more affected components. The coordinated sequence may include rewriting configuration files, updating operational parameters, stopping processes, starting processes, or resetting processes associated with a radio unit, a distributed unit, a centralized unit, an L1 process, or a gNB process. This coordination is useful when an effective mitigation requires more than a single parameter write and instead depends on a controlled lifecycle transition of one or more cell components.

This interaction among ACR Decision Logic 324, 5G RAT Provider 328, and gNB Management Front & Back End 326 supports abstraction of deployment details from the interference engine. ACR Decision Logic 324 can select a mitigation based on interference understanding and cell context. 5G RAT Provider 328 can translate that mitigation into a deployment-compatible command set, and gNB Management Front & Back End 326 can then execute the required lifecycle functions for the specific implementation. Because those responsibilities are separated, the platform can support heterogeneous deployments while preserving a consistent internal mitigation workflow. This is particularly helpful where vendor support for standardized O-RAN telemetry and control interfaces is uneven.

Across these operating phases, Pod: ACSVC contains EMS 308, Object Database 316, and Timeseries Database 318 to provide management and persistence functions. EMS 308 provides management functions for the resilient platform and, in some embodiments, for managed radio access components that interact with the platform. Those functions may include configuration management, fault management, performance monitoring, and security management. Object Database 316 persists structured system data that represents components, configurations, policies, and deployment relationships. Timeseries Database 318 persists time-stamped metrics, logs, event histories, and command status information. Because Pod: ACSVC is shown as communicating with the other pods, persisted state and management data can support detection, characterization, decision-making, execution, and feedback. In some embodiments, historical KPM information, interference event data, interference characterization data, and reconfiguration outcomes are retained so that later processing can evaluate what occurred before and after a mitigation action.

Viewed as a whole, architecture 300 shows a resilient cell platform that can detect an interference condition affecting a 5G cell and initiate acquisition of I/Q data associated with radio-frequency signals in the operating band of that cell. The platform can generate an interference characterization report indicating one or more spectral characteristics of an interfering signal, determine a mitigation command based on the report and cell configuration information, translate that command through a 5G radio access translation layer, and cause the 5G radio access network implementation to reconfigure the cell to reduce the effect of the interfering signal. As shown across FIGS. 3A and 3B, these functions can be implemented without tying the decision engine to one vendor’s controller stack or one management interface. That modularity allows the same core interference logic to be deployed across different 5G environments while preserving a common internal command model and while using whichever telemetry and management paths are actually available in the field.

FIG. 3B presents a related architecture in which signal-domain acquisition is obtained from fronthaul-related traffic rather than from External Software Defined Radio 302, but the same overall control loop is preserved. In FIG. 3B, eCPRI Decoding 332 provides recovered I/Q data to Interference Characterization and Classification 334. Near RT RIC and/or SMO 336 is positioned with gNB (CU/DU) 348. The managed radio access network is illustrated by 5G Core Network 350. Packet Capture 352 is positioned on the Open-FH path between gNB (CU/DU) 348 and RU 354 and supplies traffic that may be used for signal recovery. In some embodiments, eCPRI Decoding 332 recovers I/Q samples by decoding evolved Common Public Radio Interface information from mirrored Open Front Haul traffic or from captured Open Front Haul packets. KPM Report 338 and KPM-NN Service 340 provide the KPM-based detection path, and ACR Decision Logic 342 and 5G RAT Provider 344 provide the mitigation selection and translation path. gNB Management Front & Back End 346 provides the deployment-specific execution path. EMS 356, Object Database 358, and Timeseries Database 360 provide management and persistence functions corresponding to those described for FIG. 3A. Accordingly, FIGS. 3A and 3B together show that the disclosed resilient platform can use different I/Q acquisition mechanisms while maintaining the same higher-level detection, characterization, decision, translation, and reconfiguration framework.

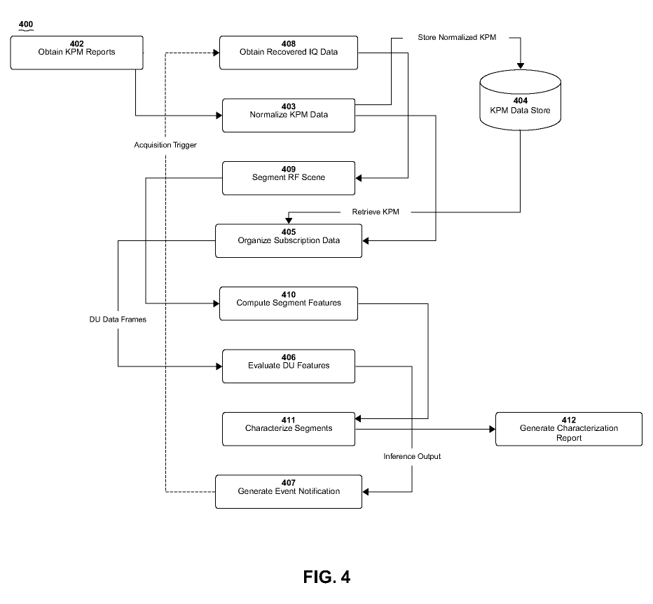

FIG. 4 illustrates a detection and characterization pipeline that processes performance metrics and recovered IQ data to produce interference notifications and characterization reports, according to some aspects of the present disclosure. Pipeline 400 includes a metric-driven detection path and an IQ-driven characterization path. These paths are coupled so that early indications from KPM processing can promptly initiate deeper signal-level analysis. In this way, pipeline 400 reduces delay between onset of an interference condition and production of spectral information that can be used by downstream mitigation decision logic. The two paths may operate within AIDAC Subsystem 103 and the recovered IQ data may be supplied by IQ Acquisition Service 105 described with respect to FIG. 1.

To begin detection, the system obtains KPM reports at operation 402 that are associated with operation of a 5G cell. The KPM reports may be received from a 5G radio access network through a reporting interface, a subscription-based feed, or another deployment interface that exposes operational metrics. The reports may be associated with one or more elements involved in serving the 5G cell, including gNB, a distributed unit, a centralized unit, a radio unit, or a control component that exposes radio access network performance data. Because those reports reflect live operating behavior of the 5G cell, they provide an initial indication that interference or another anomaly may be affecting service.

After receipt, the KPM reports are normalized at operation 403 into normalized KPM data structures. This lets later processing operate on a consistent representation even when the original reports differ in format or source. The normalized KPM data structures may preserve metric values and context that remains relevant to later detection, including timing information and reporting associations that identify how the data was produced. The normalized KPM data structures may be stored in KPM Data Store 404, which may hold recent normalized KPM history for use by the detection path and for later inspection of cell behavior surrounding an event. Persisting the normalized KPM data structures also allows pipeline 400 to maintain continuity between incoming reports and later event generation. In some embodiments, the system captures a history of normalized KPM data in response to an interference event notification so that conditions leading to the detected event are preserved for subsequent analysis.

The normalized stream is then organized at operation 405 using subscription identifiers associated with the KPM reporting stream. This allows data from different reporting contexts to be separated before feature evaluation. That organization may separate centralized-unit data frames from distributed-unit data frames when the detection logic relies on distributed-unit behavior for interference inference. In certain embodiments, centralized-unit data frames are discarded, while distributed-unit data frames are cleaned and prepared for feature extraction. The resulting distributed-unit ("DU") content is evaluated as DU Features at operation 406. In some embodiments, the feature evaluation is performed by a neural network trained using KPM data from non-interference operating conditions and KPM data from interference operating conditions. In some embodiments, another inference engine may be used when it is configured to distinguish interference-related behavior from normal cell behavior using the normalized and organized KPM inputs. Because the KPM path operates on live operational reports, the inference engine may evaluate updates on a millisecond timescale when the reporting cadence and available compute resources support that rate. The resulting inference output can indicate onset of interference within milliseconds, which allows the system to move quickly from operational symptoms to signal-level investigation.

When the evaluated DU Features indicate a likely interference condition, operation 407 generates an event notification. The event notification may indicate presence of interference affecting the 5G cell, or another anomaly that warrants further characterization. The event notification may package detection signals produced by the KPM inference path together with contextual information that helps identify the affected operating condition. Because the event notification is generated from the metric-driven path, it can be used as a practical bridge between coarse operational symptoms and detailed radio-frequency analysis. The event notification may therefore be provided to a mitigation system, to an IQ acquisition function, or to both.

In the illustrated embodiment, the event notification triggers operation 408 to obtain recovered IQ data. The recovered IQ data represents IQ samples associated with radio-frequency signals in an operating band of the 5G cell. As described with respect to FIG. 4, those samples may be obtained from recovered fronthaul data. In some embodiments, the recovered IQ data is obtained by decoding eCPRI traffic from a mirrored Open Fronthaul interface or from packet captures of Open Fronthaul traffic. In some embodiments, the recovered IQ data may instead be provided by an external radio-frequency sensor, including an external software-defined radio. Regardless of source, the recovered IQ data provides signal-level information that is more detailed than the KPM reports and is therefore suitable for interference characterization.

Once recovered IQ data has been obtained, operation 409 segments the radio-frequency ("RF") Scene represented by the recovered IQ data for the relevant band or interval. Segmentation divides that scene into IQ segments that can be examined individually rather than treating the entire capture as a single undifferentiated signal block. Segment metadata may also be produced during this operation. That metadata may preserve context needed for later characterization, including timing relationships and spectral position within the observed scene. By isolating portions of the recovered IQ data in this manner, pipeline 400 prepares the signal stream for targeted feature extraction and classification.

The resulting IQ segments are then processed at operation 410 to compute Segment Features. These features may capture properties that help distinguish one type of signal content from another and that support later identification of an interfering source or interference class. The features may reflect spectral behavior, temporal behavior, modulation-related behavior, or a combination of those characteristics as represented in the recovered IQ data. Because the characterization path is based on the recovered IQ representation rather than the source mechanism used to acquire it, the same feature computation stage may be applied to recovered fronthaul samples, packet-capture-derived samples, or externally collected samples. This provides a common basis for later characterization even when deployments use different acquisition sources.

Using the computed Segment Features and the segment metadata, operation 411 characterizes Segments to determine what the segmented signal content represents within the observed radio-frequency scene. In some embodiments, the characterization identifies whether a segment corresponds to narrowband interference, broadband interference, or another 5G signal that overlaps the 5G cell. The characterization may also identify signal-on-signal interference in which an interfering signal overlaps a 5G signal served by the gNB. In addition, the characterization may determine spectral characteristics of the segment that are useful for mitigation selection, including a frequency position within the operating spectrum, an occupied bandwidth, a modulation type, a signal type, or direction of arrival when that information is available from the recovered IQ data and associated processing chain.

After characterization, operation 412 generates a Characterization Report from the characterized Segments. The Characterization Report may identify at least one spectral characteristic of an interfering signal so that downstream logic can understand not merely that interference exists, but how that interference occupies the spectrum of the 5G cell. In some embodiments, the Characterization Report specifies a center frequency, bandwidth, spectral location, modulation type, signal type, direction of arrival, a narrowband interference classification, a broadband interference classification, or an indication that another 5G signal overlaps the 5G cell. The Characterization Report may therefore convert raw or recovered IQ samples into actionable spectral descriptors that can be consumed by mitigation decision logic described with respect to FIG. 4.

Taken together, pipeline 400 couples rapid KPM-based detection with more detailed IQ-based characterization. The metric-driven path produces an interference event notification and associated operational context. The IQ-driven path produces a Characterization Report that describes the interfering signal in spectral terms. Both outputs may be supplied to later decision logic so that a mitigation command can be selected based on the detected condition and the characterized radio-frequency scene. This combination supports prompt detection while still providing the richer signal understanding needed for effective interference mitigation in a 5G deployment.

FIG. 5 illustrates a mitigation decision-making and reconfiguration architecture that selects a mitigation command and translates the command into coordinated radio access network control actions, according to some aspects of the present disclosure. Architecture 500 may be used by AIMS Subsystem 107 and RAT Provider 109 described with respect to FIG. 1. In this view, architecture 500 receives inputs that indicate an interference condition and its character, and then converts those inputs into a controlled reconfiguration of a target 5G radio access network deployment. The figure therefore shows how a mitigation decision can remain vendor independent at the decision stage while still being carried through to concrete deployment-specific control actions.

When an interference condition is identified for an affected 5G cell, Decision Logic 502 determines what mitigation action should be applied. Decision Logic 502 may receive an interference event notification, an interference characterization report, and configuration information that describes the current operating state of the cell. The interference characterization report may indicate where an interfering signal lies within the operating bandwidth of the 5G cell. It may also indicate whether the interference is concentrated near a band edge or overlaps a more central portion of the occupied spectrum. The configuration information may identify the current channel, bandwidth, and operating constraints of the cell. In some embodiments, Decision Logic 502 also receives status information from 5G RAN Implementation 509 through RAT Provider 505 so that a selected mitigation action is compatible with the actual state and capabilities of the target deployment.

To make that decision, Decision Logic 502 may evaluate both interference location and spectrum availability before selecting the mitigation command. When the interfering signal is determined to affect an edge portion of the operating bandwidth, Decision Logic 502 may select a reduced bandwidth so that the 5G cell continues operating while avoiding the affected spectral edge. When alternate spectrum is available, Decision Logic 502 may instead select a change in channel or spectrum assignment. Where a frequency move is not selected or not available, Decision Logic 502 may select a mitigation action that changes how the cell uses its existing spectrum. That action may include dynamic power adaptation, beamforming, beam nulling, scheduling adjustment, or resource allocation adjustment, depending on the capabilities exposed for the deployment. In this manner, architecture 500 supports mitigation selection that is tied to the character of the interference rather than to a fixed vendor procedure.

The selection may also be constrained by policy and deployment limits. Mitigation Policy Store 503 provides policy inputs to Decision Logic 502 and may store policy data, deployment constraints, configuration rules, supported actions, and operating limitations that apply to the target 5G radio access network implementation. Those stored inputs may identify which mitigation techniques are permitted for a given deployment and which target operating parameters are valid for the affected 5G cell. Mitigation Policy Store 503 may also identify available operating channels, bandwidth options, power constraints, beam-control capabilities, and scheduling constraints when those capabilities are defined for the deployment. By consulting Mitigation Policy Store 503, Decision Logic 502 can avoid selecting a mitigation action that cannot be executed safely or that would conflict with deployment policy.

Once the decision is made, Mitigation Command 504 represents the decision output of Decision Logic 502. In the illustrated embodiment, Mitigation Command 504 is a vendor-independent command. Stated differently, it expresses what mitigation result is desired without requiring Decision Logic 502 to encode the deployment-specific steps needed to achieve that result. This separation allows the same decision interface to be used across different 5G radio access network implementations even when those implementations expose different control mechanisms. Mitigation Command 504 may therefore identify a high-level action, including dynamic bandwidth adaptation, dynamic spectrum access, dynamic channel assignment, dynamic power adaptation, beamforming, beam nulling, scheduling adjustment, resource allocation adjustment, or changing an operating channel of the 5G cell.

After Mitigation Command 504 is selected, RAT Provider 505 translates that command into one or more commands that are compatible with the target deployment. RAT Provider 505 may expose a standardized application programming interface to Decision Logic 502 so that Decision Logic 502 does not need to track vendor-specific management syntax, interface semantics, or lifecycle sequences. RAT Provider 505 may thus operate as an abstraction layer between a common internal mitigation command and heterogeneous radio access network control mechanisms. In some embodiments, RAT Provider 505 translates the vendor-independent command into a vendor-specific or deployment-specific command for a gNB manager, a RIC, an rApp, an xApp, an element management system, or a proprietary 5G radio access network interface. In certain embodiments, the translation targets a management or control interface associated with an O1 interface or an E2 interface when that interface is supported by the deployment.

The translated control action is then carried toward 5G RAN Implementation 509 through RAN Control Interface 506, which may correspond to the specific control path that is available in the deployment being managed. In some embodiments, RAN Control Interface 506 is a controller interface. In some embodiments, it is an element management interface, a gNB management interface, or a proprietary management path. This layer allows architecture 500 to preserve the common decision interface at the upstream side while still using the control mechanism that the downstream deployment actually accepts. Where a standardized reconfiguration path is unavailable, RAT Provider 505 may use an internal management service that exposes control endpoints and performs process management for the 5G cell.

When the selected mitigation requires coordinated changes across several running components, command translation alone may be insufficient. For that reason, the translated control action may be staged through Command Queue 507 before being applied. Command Queue 507 may hold commands that change configuration, rewrite configuration files, stop processes, start processes, reset processes, or invoke related lifecycle operations. Staging the commands in Command Queue 507 allows the deployment-specific reconfiguration to be performed in an ordered manner instead of as an uncoordinated set of direct calls. That arrangement is useful when a mitigation action affects more than one component or when a component should not be restarted until a prior configuration update has completed. In some embodiments, Command Queue 507 is implemented through a backend service that inserts a command into a persistent store and a command runner that retrieves the staged command for execution. The use of staged execution can provide a controlled handoff between a high-level mitigation decision and the lower-level operations needed to implement that decision in the target 5G deployment. It also allows architecture 500 to track pending and applied reconfiguration actions while keeping Decision Logic 502 separate from deployment-specific startup and restart mechanics.

Execution of the staged reconfiguration may then be coordinated by Supervisor Component 508. Supervisor Component 508 may control lifecycle and functionality of lower stack radio access network components and related processes within 5G RAN Implementation 509. In some embodiments, Supervisor Component 508 handles events from controllers according to a command pattern so that lifecycle actions are executed in a defined sequence. Supervisor Component 508 may start, stop, reset, or otherwise coordinate processes in response to the staged command. Supervisor Component 508 may also provide process state information that is returned upstream for visibility, status tracking, or subsequent mitigation decisions.

5G RAN Implementation 509 represents the target system that is reconfigured to reduce the effect of the detected interference. As shown, 5G RAN Implementation 509 includes RU Component 510, DU Component 511, and CU Component 512. The figure therefore reflects that the selected mitigation may affect one part of the radio access network stack or may affect several parts in combination. The translated and staged reconfiguration can be applied to an open radio access network deployment or to a proprietary deployment, provided that RAT Provider 505 can access an appropriate control path for that deployment.

During that reconfiguration, actions affecting RU Component 510 may change radio-facing behavior of the cell. Actions affecting DU Component 511 may alter scheduling, resource allocation, or lower-layer operation. CU Component 512 may be affected when the selected mitigation has consequences for centralized control-plane or user-plane behavior associated with the reconfigured cell. The dashed relationships shown among RU Component 510, DU Component 511, and CU Component 512 indicate that these components are part of an integrated 5G radio access network implementation. Those dashed relationships also indicate that a coordinated mitigation may propagate across component boundaries rather than remaining isolated to a single element.

Coordinated execution through Command Queue 507 and Supervisor Component 508 can therefore be used to apply a mitigation action safely across 5G RAN Implementation 509. In some embodiments, the staged reconfiguration includes updating configuration data and then performing lifecycle operations in a deployment-defined order. In some embodiments, that coordinated execution includes stopping, starting, resetting, or rewriting configuration for one or more of RU Component 510, DU Component 511, CU Component 512, Layer 1 processes, or gNB processes. Where the deployment maintains configuration constraints for valid radio settings, those constraints may be checked before the updated configuration is applied. This coordinated approach reduces the need for Decision Logic 502 to encode vendor-specific process ordering while still allowing the selected mitigation to be enforced at the concrete implementation level.

Architecture 500 thus addresses two practical concerns that arise in interference mitigation for 5G systems. One concern is how to choose a mitigation action from interference location and available spectrum context. Decision Logic 502 addresses that concern by selecting Mitigation Command 504 from the interference characterization report, cell configuration information, and policy inputs. The second concern is how to apply that selected action across heterogeneous deployments without exposing vendor-specific control details to the decision layer. RAT Provider 505, RAN Control Interface 506, Command Queue 507, and Supervisor Component 508 address that concern by translating vendor-independent Mitigation Command 504 into deployment-specific control actions and then sequencing those actions so that 5G RAN Implementation 509 is reconfigured in a coordinated manner.

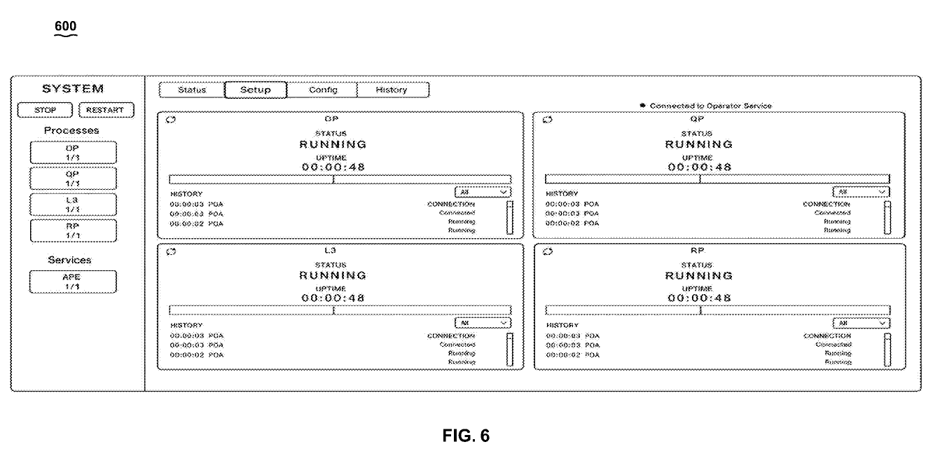

FIG. 6 illustrates a user interface view for monitoring and controlling operational state of a resilient 5G deployment, according to some aspects of the present disclosure.

FIG. As a result, operational visibility and automated control can share a common control path.

When a mitigation decision has already been made by upstream decision logic, the interface provides a concrete execution path for the selected mitigation command. On the left side of user interface 600, system-level controls labeled STOP and RESTART may invoke lifecycle actions for a managed 5G deployment. In use, those lifecycle actions can stop a cell, restart one or more gNB processes, or apply a staged reconfiguration that updates deployment settings and then brings affected processes back into service.

After startup, restart, or reconfiguration, user interface 600 can be used to verify that expected software elements are present and operating. On the left side, a Processes region lists OP, QP, L3, and RP, each with a running count, and a Services region lists APE with a running count. These displayed counts provide an immediate indication of whether expected process instances and expected supporting services are present. In that way, user interface 600 supports verification that a mitigation action has propagated to the managed deployment and that the relevant software stack has returned to an operational state.

The management service can expose different views of the same controlled deployment through tabs across the top of the main display area. User interface 600 includes tabs labeled Status, Setup, Config, and History. The Status view can present current execution state. The Config view can expose configuration parameters that are changed when the cell is reconfigured in response to interference. The History view can preserve prior state transitions, command activity, or service events. The Setup view can expose deployment-specific settings used by the management stack that carries out lifecycle control.

During monitoring of the managed deployment, the main display area provides process-specific state information for the software layers being controlled. Four main status panels correspond to OP, QP, L3, and RP. Each panel shows a current STATUS of RUNNING and an UPTIME value. Each panel also includes a HISTORY area and a CONNECTION area. The HISTORY area indicates recent events associated with the corresponding process group, while the CONNECTION area indicates whether that process group is connected and running. A refresh control is also shown for each panel, which indicates that process-state information may be updated as the managed deployment changes state. The displayed indicator “Connected to Operator Service” further shows that the local management view can remain linked to a higher-level operator-facing service during monitoring and control.

Within the resilient cell architecture, the management-plane capability represented by user interface 600 may operate downstream of interference detection, interference characterization, and mitigation decision functions. Those upstream functions can receive KPM reports associated with operation of the 5G cell, detect an interference condition, trigger acquisition of I/Q data, and generate an interference characterization report that identifies one or more spectral characteristics of an interfering signal. Based on that characterization report and on configuration information for the 5G cell, decision logic can then determine a mitigation command. User interface 600 is therefore well suited to represent an execution endpoint where a translated reconfiguration command is carried out and where its effect on managed processes is exposed for observation.

Because 5G deployments do not always provide a complete standardized reconfiguration interface, the management capability represented by user interface 600 can serve as a substitute or supplemental control path. In some embodiments, a 5G radio access technology provider translates a vendor-independent mitigation command into deployment-specific actions for a non-real-time controller, an rApp, or another standardized management interface when that interface is available. In some embodiments, the 5G radio access technology provider instead communicates with a gNB management service that exposes internal application programming interfaces for lifecycle control. Through that path, the translated command can cause configuration files to be rewritten. It can also cause affected software elements to be stopped and the deployment to be restarted in a defined sequence so that the 5G cell is reconfigured to reduce the effect of the interfering signal.

Once reconfiguration has been initiated, user interface 600 can provide status feedback to the same translation and decision framework that initiated the reconfiguration. As shown, user interface 600 presents a SYSTEM view with STOP and RESTART controls, tabs for Status, Setup, Config, and History, process listings for OP 1/1, QP 1/1, L3 1/1, and RP 1/1, and a services listing for APE 1/1. The interface also shows panels for OP, QP, L3, and RP, each with STATUS RUNNING, UPTIME 00:00:48, HISTORY entries including 00:00:03 POA, 00:00:03 POA, and 00:00:02 POA, CONNECTION information including Connected and Running, and an All selection control, while the QP panel further indicates Connected to Operator Service. Those displayed process states, uptimes, connection indications, and history entries may be used to confirm whether a commanded reconfiguration has completed successfully. That feedback can be returned through the radio access technology provider to decision logic as current deployment status. In this way, the control architecture remains modular. Detection, characterization, decision, translation, and management functions can be deployed in different software locations, while user interface 600 still provides a common operational view of the managed 5G cell.

In some embodiments, the management path represented by user interface 600 is used in an architecture that also acquires I/Q data from mirrored open fronthaul traffic, decoded eCPRI traffic, packet captures, an external software-defined radio, or a receive path associated with the radio unit. In those embodiments, the richer signal analysis remains separate from the management-plane execution shown in FIG. 6. Even so, after the interfering signal has been characterized by frequency location, bandwidth, overlap with the operating band of the 5G cell, modulation characteristic, or interference type, the resulting mitigation command can still be applied through the management capability represented by user interface 600. This separation helps preserve a vendor-independent decision layer while still allowing deployment-specific control of the underlying 5G stack.

The architecture shown in FIG. 6 also supports coordinated reconfiguration of multiple software layers of a 5G cell. A back-end management service may queue or otherwise stage commands, while a supervisor or comparable control component may execute a predefined stop and start sequence for processes associated with the radio unit, distributed unit, centralized unit, Layer 1 processing, or gNB functions implemented in the deployment. User interface 600 gives visibility into that coordinated activity. As a result, the resilient cell platform can apply interference mitigation through a practical management path, even in heterogeneous deployments where standardized telemetry or reconfiguration support is missing, incomplete, or vendor specific.

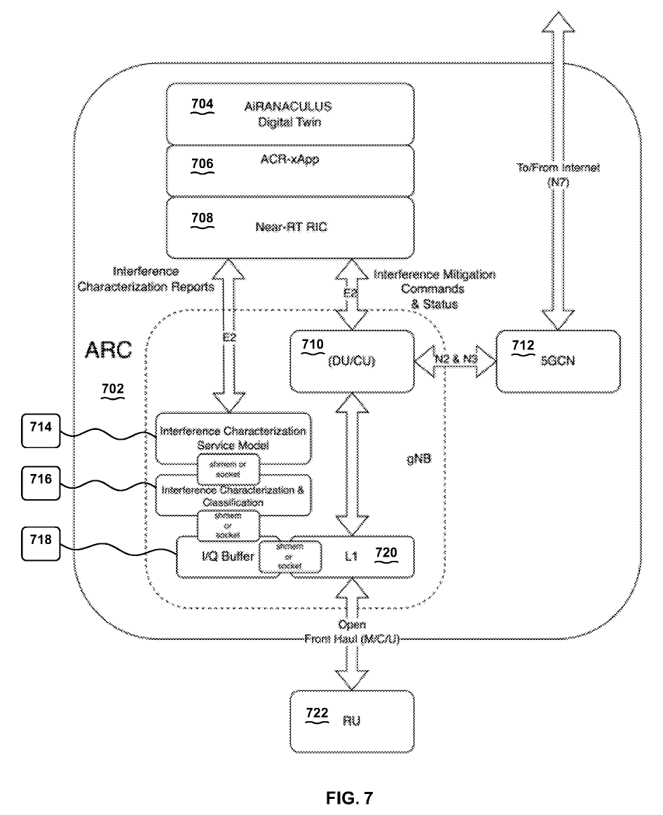

FIG. 7 illustrates an architecture in which interference characterization functions are integrated with 5G radio access network infrastructure and controller-based mitigation functions, according to some aspects of the present disclosure.

FIG. Within ARC 702, this closed-loop behavior may be coordinated across AiRANACULUS Digital Twin 704, ACR-xApp 706, Near-RT RIC 708, and the gNB functions, so that characterization results are delivered to controller logic without requiring that controller logic to perform low-level signal processing itself.

When an interference condition or anomaly is indicated, operational context may be drawn from the upper portion of ARC 702. AiRANACULUS Digital Twin 704 may maintain deployment information used by mitigation logic, including current cell configuration, available operating spectrum, and state information for the affected deployment. ACR-xApp 706 may execute application logic that consumes interference-related outputs and determines a mitigation approach. Near-RT RIC 708 provides a near-real-time control layer through which controller applications interact with the gNB. In the illustrated arrangement, Near-RT RIC 708 exchanges Interference Characterization Reports with the characterization path over an E2 path. Near-RT RIC 708 also exchanges Interference Mitigation Commands & Status with DU/CU 710 over an E2 path.

The gNB-side path may keep the radio-frequency inspection functions close to the radio stack so that event-related samples can be acquired with limited separation from the serving cell processing chain. DU/CU 710 represents distributed-unit and centralized-unit functionality of the gNB. DU/CU 710 communicates with 5GCN 712 over N2 and N3 for control-plane and user-plane connectivity, and also exchanges data and control information with L1 720 within the gNB. L1 720 is coupled to RU 722 over Open Front Haul, shown as management, control, and user-plane traffic. In the illustrated embodiment, the interference characterization path is placed close to L1 720 so that I/Q data associated with radio-frequency activity in the operating band of the cell can be captured or staged for analysis.

Inside the dashed gNB region in FIG. 7, Interference Characterization Service Model 714, Interference Characterization & Classification 716, I/Q Buffer 718, L1 720, and DU/CU 710 may cooperate to convert raw baseband information into a controller-consumable output. In use, I/Q Buffer 718 stores or stages captured I/Q samples before or during processing by Interference Characterization & Classification 716. As shown in the figure, communication between these components may occur through shared memory or a socket. The same type of local interface may be used between I/Q Buffer 718 and L1 720. This arrangement allows event-associated samples to be captured, held, and then analyzed without requiring the controller-side components to directly access raw baseband data. In some embodiments, the buffer stores samples associated with a detected interference window so that characterization is performed on data that is temporally related to the interference event identified from KPM reports.

After sample acquisition, Interference Characterization & Classification 716 performs analysis on I/Q data associated with the event under investigation. In some embodiments, this function operates after a KPM-based interference detection service has determined that a cell is experiencing an interference condition or anomaly. The KPM-based detection may be produced by a neural network or another inference engine trained using KPM data associated with non-interference operation and interference operation. Once an onset of interference is detected, the architecture can initiate I/Q acquisition and deliver the resulting samples to Interference Characterization & Classification 716 for deeper analysis. That analysis may include segmenting a radio-frequency scene represented by the I/Q data, computing features for resulting I/Q segments, and characterizing those segments to identify the interfering emission.

The resulting characterization may then be exposed through Interference Characterization Service Model 714 toward the controller-facing side of the architecture. In use, this service model can package or expose an interference characterization report in a form that Near-RT RIC 708 and ACR-xApp 706 can consume. The report may indicate one or more spectral characteristics of an interfering signal, including a frequency location within the operating spectrum, occupied bandwidth, modulation-related information, signal type, or an indication that the interference is narrowband, broadband, or another 5G signal overlapping the served cell. By presenting the characterization results through a service model, the architecture separates signal-analysis details from the mitigation application logic.

Although FIG. 7 shows an internal path in which I/Q Buffer 718 is fed from L1 720, the same interference characterization flow may be triggered when the I/Q data is acquired from an external software-defined radio or another external radio-frequency sensor rather than from a mirrored Open Front Haul or decoded evolved Common Public Radio Interface stream. This path is useful in deployments in which mirrored open-fronthaul traffic is unavailable, internal eCPRI access is not exposed, or direct signal access inside vendor equipment is impractical. In such embodiments, an I/Q collector service may control the external software-defined radio to acquire samples associated with the operating band of the affected 5G cell and then provide those samples to I/Q Buffer 718 or directly to Interference Characterization & Classification 716. The I/Q collector service may set capture parameters for the external software-defined radio, including sampling rate, tuning frequency, gain, trigger conditions, or capture duration, based on the detected event and the known configuration of the cell.

Because the acquisition path may vary by deployment, the illustrated architecture supports a deployment-flexible approach to interference characterization. In some embodiments, the external software-defined radio supplements a fronthaul-derived I/Q acquisition path rather than replacing it. In some embodiments, multiple external software-defined radios or radio-frequency sensors are positioned at different locations to improve spatial diversity or direction finding for the interfering signal. In some embodiments, an external sensor is integrated with or co-located near RU 722, near a site monitoring device, or at another location associated with the serving cell. Regardless of the collection source, the downstream characterization flow may remain the same so that controller logic receives a consistent characterization output.

Once the interference has been characterized, the information produced by Interference Characterization & Classification 716 can support selection of a mitigation command by ACR-xApp 706, by logic associated with AiRANACULUS Digital Twin 704, or by another decision component within ARC 702. That decision logic may evaluate whether the interfering signal overlaps a center portion or an edge portion of the operating bandwidth of the 5G cell. The decision logic may further consider whether alternate spectrum is available. Based on that evaluation, the mitigation command may specify dynamic bandwidth adaptation, dynamic spectrum access, dynamic channel assignment, dynamic power adaptation, beamforming, beam nulling, scheduling adjustment, resource allocation adjustment, or a change in operating channel. This permits the mitigation decision to be driven by spectral understanding of the interference instead of by KPM degradation alone.

After a mitigation approach is selected, Near-RT RIC 708 may communicate the selected mitigation action toward DU/CU 710 as an interference mitigation command, and status information may be returned on the same controller-facing path. In some embodiments, the mitigation command is generated in a vendor-independent form. It can then be translated into one or more deployment-specific reconfiguration commands compatible with the target 5G radio access network implementation. The translation may be carried out by a radio access technology provider or provider wrapper associated with the deployment. Through that adaptation layer, a common mitigation decision can be mapped to the interfaces and control actions supported by a particular gNB environment.

The resulting reconfiguration may affect one or more portions of the illustrated gNB stack, including DU/CU 710, L1 720, or RU 722, depending on the selected mitigation technique and the capabilities exposed by the deployment. In some embodiments, reconfiguration is staged through a management-plane component that coordinates command execution and process state. In this way, FIG. 7 shows a closed-loop architecture in which interference is detected from network behavior, characterized from I/Q data, translated into a mitigation decision, and applied back to the 5G cell to reduce the effect of the interfering signal.

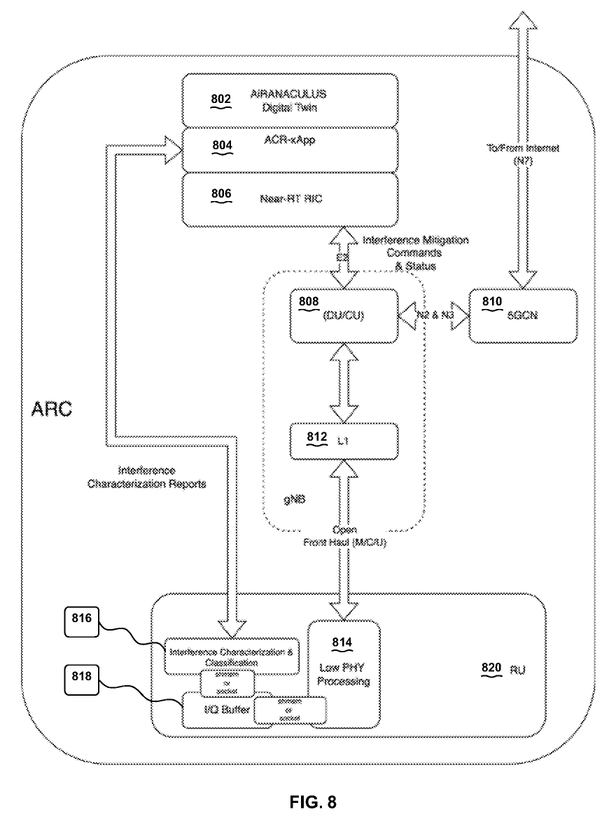

FIG. 8 illustrates an architecture in which interference characterization functions are integrated near radio-unit processing resources while controller-based mitigation functions reconfigure a 5G deployment, according to some aspects of the present disclosure.

FIG. AiRANACULUS Digital Twin 802 may maintain system context for the serving cell, including configuration information and current operating state, and that context can be used when selecting a mitigation response. When an Interference Characterization Report is available, ACR-xApp 804 may receive the report and determine a mitigation command for the affected 5G cell based on the report and the maintained cell context. Near-RT RIC 806 provides a controller path through which Interference Mitigation Commands & Status may be exchanged with the gNB over the E2 interface shown in the figure.

The serving cell may be reconfigured through the gNB portion of the deployment represented by DU/CU 808 and L1 812. DU/CU 808 communicates with 5GCN 810 over the N2 and N3 interfaces shown in the figure, and DU/CU 808 also exchanges lower-layer information with L1 812. L1 812 in turn exchanges Open Front Haul management, control, and user-plane traffic with RU 820. This arrangement allows a mitigation function selected at the controller side to be carried into the serving cell through existing radio access network control paths. At the same time, signal data used for characterization may be obtained close to the radio processing path.

Near RU 820, recovered or locally available I/Q data may be captured and analyzed without requiring a remote characterization stage. As shown inside RU 820, Low PHY Processing 814, Interference Characterization & Classification 816, and I/Q Buffer 818 are arranged so that such analysis occurs near the radio unit. Low PHY Processing 814 represents physical-layer processing associated with the radio unit receive path. I/Q Buffer 818 stores I/Q samples and associated metadata for later analysis. The figure shows local communication between these elements through shared memory or a socket interface. That local arrangement supports capture of a radio-frequency scene in response to an interference trigger and supports transfer of the captured samples to Interference Characterization & Classification 816.

Once the samples are available, Interference Characterization & Classification 816 processes the I/Q data to generate the Interference Characterization Reports shown in the figure. In some embodiments, that processing includes segmenting the radio-frequency scene represented by the I/Q data, computing features for resulting I/Q segments, and characterizing the resulting I/Q segments to identify one or more spectral characteristics of an interfering signal. The resulting report may indicate a frequency location within the operating spectrum of the 5G cell, bandwidth, modulation-related behavior, signal type, or whether the interference is narrowband interference, broadband interference, or another 5G signal overlapping the serving cell. In some embodiments, the report further distinguishes whether the interfering energy occupies a center portion or an edge portion of the operating bandwidth, so that downstream mitigation logic can select a more appropriate corrective action.

The same characterization flow may be used even when direct mirrored fronthaul access is unavailable, undesirable, or supplemented by local sensing. In some embodiments, the I/Q data provided to I/Q Buffer 818 is obtained from an external software-defined radio under control of an I/Q collector service, even though the characterization pipeline remains positioned near RU 820 as shown. The I/Q collector service may control the external software-defined radio by setting a tuning frequency, a sampling rate, a capture duration, and one or more capture parameters that align the collection with the affected operating band of the 5G cell. The I/Q collector service may select those capture settings in response to an interference event notification, and may use stored cell configuration information or policy information when doing so. This permits interference characterization to proceed without modifying deployed radio hardware and provides flexibility in deployments where mirrored Open Front Haul or vendor-supported I/Q export is not accessible.

Because the source of I/Q data can vary while the characterization and mitigation flow remains consistent, FIG. 8 supports use of externally captured samples alone or in combination with samples recovered from fronthaul-related sources. In some embodiments, externally captured I/Q data is used together with mirrored Open Front Haul data, eCPRI-decoded data, or packet-capture-derived data for cross-validation, improved confidence, or expanded observability of local radio-frequency conditions. In some embodiments, the external software-defined radio is positioned at or near a cell site, antenna structure, user area, facility interior, or another monitoring location selected to observe local radio conditions relevant to the affected cell.

After ACR-xApp 804 receives the Interference Characterization Report, ACR-xApp 804 may select a mitigation technique that is compatible with the detected interference condition and with the current configuration of the 5G cell. The mitigation command may represent a vendor-independent internal decision, and Near-RT RIC 806 may communicate that decision toward the gNB using the E2 path shown in the figure. The commanded reconfiguration may affect DU/CU 808, L1 812, RU 820, or a combination of those elements. In some embodiments, the mitigation changes operation of the cell through dynamic bandwidth adaptation, dynamic spectrum access, dynamic channel assignment, dynamic power adaptation, beamforming, beam nulling, scheduling adjustment, resource allocation adjustment, or a change in operating channel.

Accordingly, FIG. 8 shows that the disclosed resilient cell framework is not limited to a single point of I/Q acquisition. The figure illustrates a deployment in which characterization is closely coupled to RU-side processing resources, while mitigation decisions remain coordinated through controller-side intelligence. That separation allows interference to be detected, characterized, and mitigated using the same higher-level decision flow even when the I/Q data is obtained from local RU-side paths, from an external software-defined radio, or from both.

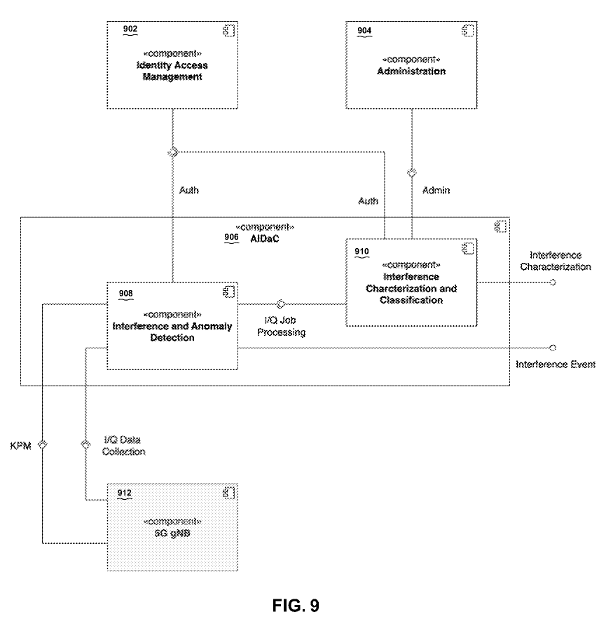

FIG. 9 illustrates a component view for an interference detection and characterization subsystem that exchanges operational data, acquired signal data, administrative data, and characterization outputs with related system components, according to some aspects of the present disclosure.

FIG. The figure therefore represents a deployment in which detection and characterization functions are grouped into a common subsystem, while identity, access, and administrative control remain available through separate interfaces. AIDaC 906 represents an Autonomous Interference Detection and Characterization subsystem, and, within AIDaC 906, Interference and Anomaly Detection 908 performs a near-real-time detection function based on operational data while Interference Characterization and Classification 910 performs a deeper signal analysis function based on acquired in-phase and quadrature data. Keeping these functions distinct supports a workflow in which key performance metrics are evaluated continuously, while I/Q-based processing is invoked in response to a detected condition. This separation reduces the need to perform full signal characterization at all times and supports faster reaction to onset conditions affecting a 5G cell.

Before underlying operation is performed, protected access to AIDaC 906 may be controlled through Identity Access Management 902 and Administration 904. In the illustrated arrangement, Identity Access Management 902 provides authentication support for protected interfaces of AIDaC 906 and is coupled to both Interference and Anomaly Detection 908 and Interference Characterization and Classification 910 through Auth connections. This arrangement allows access to metric ingestion paths, I/Q processing paths, report retrieval paths, and management functions to be controlled before the underlying operation is performed. In some embodiments, Identity Access Management 902 applies user-specific or service-specific credentials so that access to detection functions, characterization jobs, and resulting outputs can be limited to authorized entities in a hybrid edge-cloud deployment. Administration 904 provides administrative access to Interference Characterization and Classification 910 through the Admin connection shown in the figure. Through Administration 904, an operator or management service may configure execution parameters used by AIDaC 906, including parameters that affect characterization processing, model selection, storage behavior, interface settings, and deployment-specific policies. Because the administrative path is shown as external to AIDaC 906, the subsystem can be managed as a distinct software element even when its functional placement is close to 5G gNB 912 or integrated into a network-side processing environment.

During detection, Interference and Anomaly Detection 908 receives KPM information from 5G gNB 912 through the KPM interface shown at the left side of the figure. The KPM information may include operational data associated with performance of the 5G cell. For example, the data may be indicative of radio conditions, congestion, or interference. In some embodiments, Interference and Anomaly Detection 908 normalizes incoming KPM reports into normalized KPM data structures. Interference and Anomaly Detection 908 stores those data structures, organizes them by subscription identifier, separates central-unit-related data from distributed-unit-related data, cleans distributed-unit data frames, extracts relevant distributed-unit features, and evaluates those features to generate an interference event notification. The evaluation may be performed by a neural network or other inference engine trained using KPM data corresponding to interference and non-interference operating conditions. When Interference and Anomaly Detection 908 detects an interference condition or anomaly, it produces the Interference Event output shown at the right side of AIDaC 906. That output may serve as a trigger for acquisition or submission of I/Q data. In this way, the system can move from fast metric-based detection to signal-based characterization without requiring constant full-band signal capture. This closer coupling between detection and characterization can reduce latency between identification of a suspected problem and production of data usable by mitigation logic.

When deeper analysis is warranted, 5G gNB 912 also supplies I/Q-related information to AIDaC 906 through the I/Q Data Collection interface shown in the figure. In some embodiments, the I/Q data is obtained from mirrored open fronthaul traffic, decoded evolved Common Public Radio Interface traffic, packet captures of open fronthaul traffic, or an external radio-frequency sensor. In some embodiments, a radio unit, a distributed unit, a gNodeB processing environment, or an associated general-purpose processor performs at least part of I/Q capture, recovery, buffering, or preprocessing before the data is provided to AIDaC 906. This arrangement allows the disclosed pipeline to reuse radio-side resources that are already present in the deployment. After I/Q data is made available, Interference and Anomaly Detection 908 and Interference Characterization and Classification 910 interact through the I/Q Job Processing connection shown between those components. That connection may represent a job submission path that identifies a capture, recovered sample set, or buffered data set for analysis. In some embodiments, the job processing path supports asynchronous exchange so that characterization can proceed after detection has triggered collection. The handoff may therefore decouple the timing of detection from the timing of deeper signal analysis while preserving the association between the detected event and the acquired signal data.

Once the handoff occurs, Interference Characterization and Classification 910 processes the acquired or recovered I/Q data to generate the Interference Characterization output shown at the right side of the figure. In some embodiments, this processing includes segmenting a radio-frequency scene represented by the I/Q data. It also includes computing features for resulting I/Q segments and characterizing the resulting I/Q segments using the segment information and computed features. The resulting interference characterization report may indicate a center frequency, bandwidth, spectral location, modulation characteristic, signal type, direction-related information, narrowband interference, broadband interference, or overlap between an interfering signal and a 5G signal of the 5G cell. The characterization may therefore identify whether the detected condition corresponds to signal-on-signal interference and may package that information into a report usable by a mitigation system.

After detection or characterization data is produced, the outputs of AIDaC 906 are suitable for downstream decision logic that selects a mitigation technique for the affected 5G cell. In some embodiments, an interference event notification or an interference characterization report is provided to mitigation logic. That mitigation logic determines whether an interfering signal occupies a center portion or an edge portion of the operating bandwidth and whether alternate spectrum is available. Based on that determination, the mitigation logic may generate a vendor-independent mitigation command corresponding to dynamic bandwidth adaptation, dynamic spectrum access, dynamic channel assignment, dynamic power adaptation, beamforming, beam nulling, scheduling adjustment, resource allocation adjustment, or a change in operating channel. That mitigation command may then be translated into deployment-specific reconfiguration commands for the applicable 5G radio access network implementation.

The same workflow is compatible with multiple deployment placements. FIG. 9 also supports an integrated deployment model in which the functional pipeline is placed closer to the radio stack than in an application architecture hosted only by external controllers. In some embodiments, AIDaC 906 is deployed within a distributed unit or 5G gNB 912 rather than in a radio intelligent controller-hosted application environment. In some embodiments, at least the I/Q collection or preprocessing portion is performed within a radio unit or a processor associated with the radio unit. In some embodiments, interference characterization is performed locally near 5G gNB 912 while mitigation decision logic remains external or centralized. These placements can reduce latency and reduce dependence on external sensing hardware. They also support deployments in which standardized controller interfaces or orchestration paths are unavailable, incomplete, or not preferred. The arrangement shown in FIG. 9 is also compatible with containerized execution on edge compute resources co-located with radio access network components. In such embodiments, AIDaC 906 may run as edge software that communicates securely with Identity Access Management 902 and Administration 904 while remaining close to 5G gNB 912 for low-latency access to KPM data and I/Q Data Collection data. Interference and Anomaly Detection 908 may operate on a near-real-time timescale, while Interference Characterization and Classification 910 may execute locally or in a non-real-time environment, depending on the available compute resources and data path. The figure therefore captures a flexible subsystem boundary that preserves the disclosed detect, characterize, and mitigation-support workflow across different 5G deployment architectures.

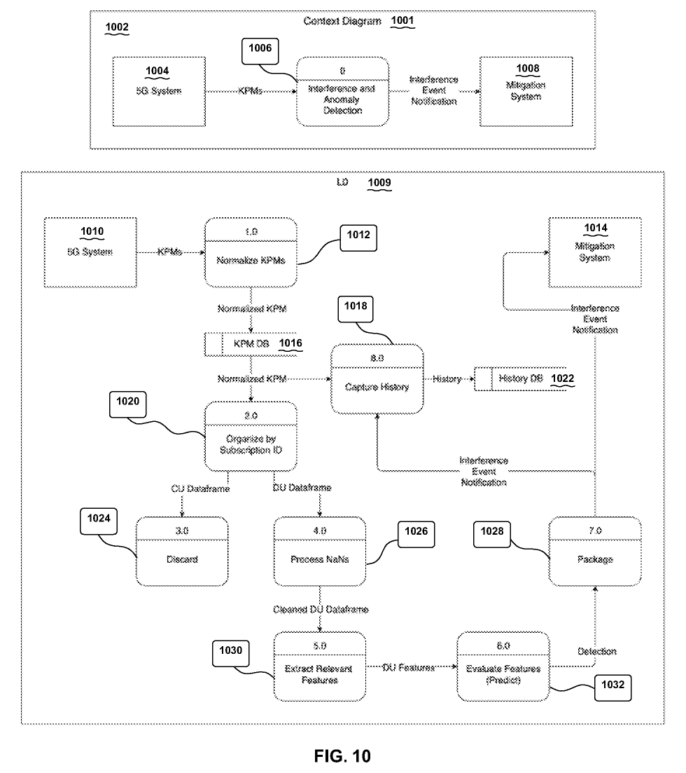

FIG. 10 illustrates a component and dataflow view for performance-based interference detection and event generation within a resilient wireless architecture, according to some aspects of the present disclosure.

FIG. 10 presents a Context Diagram 1001 and an L0 1009 decomposition of the detection function. The upper portion provides a simplified system view, and the lower portion provides an internal functional view that explains how key performance metric data is converted into an interference event notification that can be consumed by downstream control logic. Read together, these views show how high-rate operational observations from a 5G cell can be organized into a scalable detection pipeline that produces a consistent trigger for later interference characterization and mitigation.

At the system level, the upper context boundary 1002 places a 5G System 1004, an Interference and Anomaly Detection function identified by operation 1006, and a Mitigation System 1008 in the same resilient cell workflow. In this view, the 5G System 1004 supplies KPMs to operation 1006, and operation 1006 processes those KPMs to detect behavior consistent with interference or another operational anomaly affecting the 5G cell. When a condition of interest is detected, operation 1006 outputs an Interference Event Notification to the Mitigation System 1008. This context shows the detection function as an event-producing stage in the broader resilient cell workflow. The event can initiate later collection and characterization of in-phase and quadrature data, and it can also provide an early indication to downstream decision logic before full spectral characterization has completed.

Within L0 1009, processing begins when 5G System 1010 provides KPMs to operation 1012, labeled Normalize KPMs. Operation 1012 converts incoming reports into normalized KPM data structures so that later stages can work from a common internal representation rather than vendor-specific formats, reporting syntax, or source-specific field layouts. In some embodiments, the normalized representation preserves subscription identifiers, timestamps, frame content, and metric values. This allows downstream logic to reconstruct event context and align records associated with the same monitored cell or reporting stream.

After normalization, the normalized KPM data is stored in KPM DB 1016, which may persist recent and historical normalized metric data for later stages of the detection pipeline. Storing the data at this point can decouple ingestion from inference. It also supports implementations in which normalization and later analysis execute in different processes, containers, or compute nodes. The stored normalized KPM data is then provided to operation 1020, labeled Organize by Subscription ID, where normalized records are grouped according to subscription identifier so that data associated with distinct reporting contexts remains separated and internally consistent. In the illustrated flow, that organization also separates CU Dataframe content from DU Dataframe content.

The resulting branches are handled differently in the depicted embodiment. The organized CU Dataframe is sent from operation 1020 to operation 1024, labeled Discard, because the CU Dataframe path is not used for the particular interference inference represented in FIG. 10. Operation 1024 therefore removes that CU Dataframe path from the feature-processing branch so that later stages focus on distributed-unit data that is more directly useful for detection. This should not be read as requiring that centralized-unit information is always irrelevant. Instead, FIG. 10 shows one implementation in which the illustrated predictor operates on distributed-unit-derived inputs.

The organized DU Dataframe is provided from operation 1020 to operation 1026, labeled Process NaNs, so the data can be cleaned before feature extraction. In this context, NaNs represent missing, invalid, or non-numeric entries that can arise in metric streams and distort later inference if left untreated. Operation 1026 may remove, replace, or otherwise process those entries to generate the Cleaned DU Dataframe shown in the figure. By conditioning the data at this stage, the pipeline improves consistency of the feature vectors presented to the prediction stage.

Once cleaned, the Cleaned DU Dataframe is supplied to operation 1030, labeled Extract Relevant Features, which derives DU Features from the metric data. These DU Features may correspond to the subset and representation of distributed-unit observations that are informative for distinguishing normal operation from interference-related behavior. This reduces the volume and dimensionality of the raw or normalized metric stream and prepares the data for a predictor that is trained or otherwise configured to recognize interference signatures. Operation 1032, labeled Evaluate Features (Predict), then receives the DU Features and produces the Detection output. In some embodiments, operation 1032 applies a neural network trained using KPM data associated with non-interference operating conditions and KPM data associated with interference operating conditions. In some embodiments, operation 1032 applies another inference engine that evaluates the DU Features to determine whether the current behavior of the 5G cell is indicative of interference or anomaly onset.

Because operation 1032 works from KPM-derived features rather than full radio-frequency sample streams, the detector can provide a fast indication that a characterization workflow should be initiated. In some embodiments, the evaluation is performed on a near-real-time basis and can indicate onset of interference on a sub-second timescale, including implementations that operate on a millisecond-scale reporting cadence when the deployment supports that cadence. The Detection output from operation 1032 is supplied to operation 1028, labeled Package, which packages the prediction result into the Interference Event Notification shown in the figure. Packaging may include placing the detection result into a structured notification that can be consumed by the Mitigation System 1014 and by subsequent characterization workflows. In some embodiments, the packaged notification includes information that identifies the affected cell or subscription, indicates the detected condition, and preserves timing or context information needed to coordinate later collection of in-phase and quadrature data. The packaged notification is then delivered to the Mitigation System 1014, which may use the notification directly or in combination with a later interference characterization report to select a mitigation technique.

The same event can also feed a history-preservation path. FIG. 10 shows operation 1018, labeled Capture History, receiving Normalized KPM data from KPM DB 1016 and also receiving the Interference Event Notification generated by operation 1028. Using those inputs, operation 1018 captures event-related history and stores that History in History DB 1022. This branch preserves the KPM context associated with a detected event. In some embodiments, the preserved history includes normalized KPM records from a period associated with the event, along with event identifiers, timestamps, subscription identifiers, and related detection context. Retaining this history supports later analysis of detected events and also supports model improvement, retraining, and audit of the detection pipeline.

Although FIG. 10 is directed to KPM-based detection, the event produced by operation 1028 also supports the larger interference-characterization architecture described elsewhere in the specification. In response to the Interference Event Notification, downstream components may initiate acquisition of in-phase and quadrature data associated with the operating band of the affected 5G cell. In some embodiments, that in-phase and quadrature data is obtained from mirrored open-fronthaul traffic, decoded evolved Common Public Radio Interface traffic, packet captures, an external radio-frequency sensor, or stored capture data. The resulting characterization workflow can segment the recovered in-phase and quadrature scene, compute features for resulting segments, and generate an interference characterization report that identifies spectral characteristics of an interfering signal. Because FIG. 10 produces a structured event rather than a source-specific trigger, multiple in-phase and quadrature acquisition paths can be supported without changing the downstream mitigation logic that consumes the resulting report.

The architecture shown in L0 1009 may be implemented as a distributed service stack or as a more consolidated software arrangement. In some embodiments, operation 1012, operation 1020, operation 1024, operation 1026, operation 1030, operation 1032, operation 1028, and operation 1018 are executed within a single process, container, or service. In some embodiments, these functions are partitioned across edge and cloud nodes so that metric ingestion and prediction occur near the 5G deployment while history retention or later characterization support executes elsewhere. Where the functions are separated, handoff between stages may be supported by a database record, a message-based transfer, a shared storage object, or a file-based job interface. These structures are implementation examples that support asynchronous or distributed processing. They are not required in every embodiment.

FIG. 10 therefore supports processing of KPM reports by normalizing the reports into normalized KPM data structures, storing the normalized KPM data structures, organizing the normalized KPM data structures by subscription identifier, discarding centralized-unit data frames, cleaning distributed-unit data frames, extracting relevant distributed-unit features, and evaluating the relevant distributed-unit features to generate an interference event notification. The figure also supports embodiments in which the predictor is a neural-network-based inference engine, in which event-related normalized KPM history is preserved for later use, and in which the resulting interference event notification serves as the trigger that connects the near-real-time KPM detection path to a later interference characterization and mitigation path within the resilient 5G architecture.

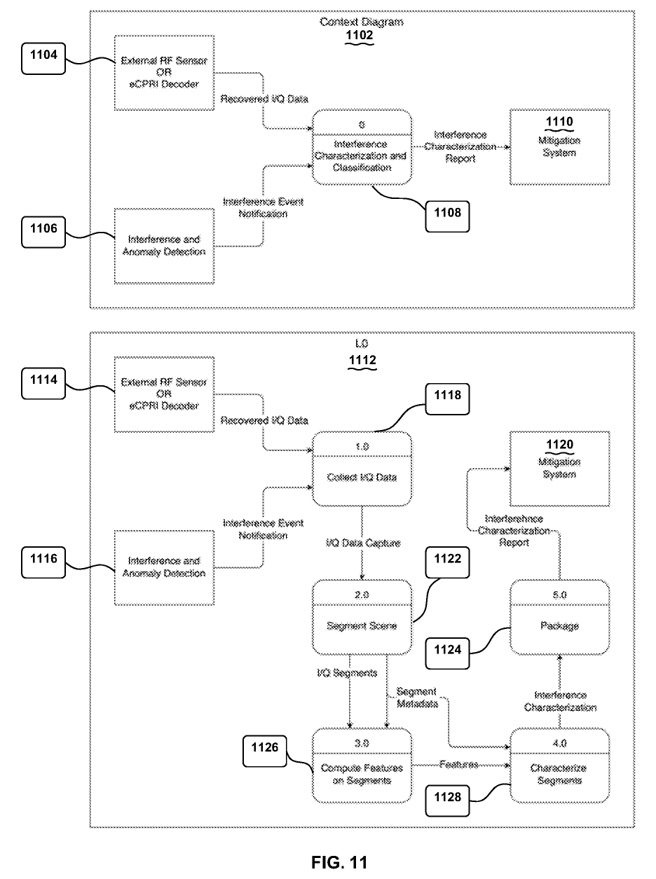

FIG. 11 illustrates a component and dataflow view for signal-based interference characterization and report generation within a resilient wireless architecture, according to some aspects of the present disclosure.

FIG. 11 includes Context Diagram 1102 and L0 1112. Context Diagram 1102 presents the characterization subsystem at a high level, and L0 1112 presents an internal processing view of that subsystem. Taken together, the figure shows how an interference event identified from operational data can trigger collection and processing of recovered in-phase and quadrature data so that the system can produce an interference characterization report for downstream mitigation logic. This arrangement supports a modular detect-characterize-mitigate workflow and allows the characterization portion to remain reusable across different 5G deployments without tying the design to one vendor-specific stack or interface.

At the higher-level view shown in Context Diagram 1102, operation begins when signal data and event context are brought together for targeted analysis. External RF Sensor OR eCPRI Decoder 1104 provides Recovered I/Q Data to Interference Characterization and Classification 1108, while Interference and Anomaly Detection 1106 provides an Interference Event Notification to Interference Characterization and Classification 1108. Interference Characterization and Classification 1108 processes these inputs and outputs an Interference Characterization Report to Mitigation System 1110. The characterization function can therefore be driven by both signal data and event context derived from key performance metric monitoring. In this way, the characterization function need not operate as an isolated spectrum analysis tool, but instead can analyze recovered I/Q data in the context of a detected condition affecting a particular 5G cell.

The input path for Recovered I/Q Data may vary across deployments while still feeding the same downstream characterization flow. External RF Sensor OR eCPRI Decoder 1104 may represent any disclosed source that provides recovered or acquired I/Q samples associated with an operating band of the 5G cell. In some embodiments, the Recovered I/Q Data is obtained from mirrored Open Front Haul traffic. In some embodiments, the Recovered I/Q Data is recovered by decoding evolved Common Public Radio Interface traffic. In some embodiments, the Recovered I/Q Data is obtained from packet captures of Open Front Haul traffic. In some embodiments, the Recovered I/Q Data is collected from an external radio-frequency sensor. In some embodiments, the external radio-frequency sensor is an external software-defined radio controlled to capture signal data associated with the affected operating band. The figure is intended to remain flexible as to the particular acquisition path while preserving a common downstream characterization flow.

Targeting of that signal analysis may come from the resilient cell detection portion rather than from untargeted capture. Interference and Anomaly Detection 1106 represents the upstream detection portion of the resilient cell architecture. That detection portion may process key performance metrics associated with operation of the 5G cell and may generate the Interference Event Notification when an interference condition or anomaly is detected. In some embodiments, the detection is based on normalized key performance metric data structures and extracted distributed-unit features. In some embodiments, the detection uses a neural network or another inference engine trained using data from interference and non-interference operating conditions. The Interference Event Notification can identify the affected cell and can carry context that helps align recovered I/Q data with the detected event. This helps direct later processing to the relevant radio-frequency scene rather than to unrelated traffic.

Once those inputs are available, Interference Characterization and Classification 1108 converts them into a characterization output that is usable by Mitigation System 1110. This conversion addresses a practical problem in resilient 5G operation. Raw or recovered I/Q data is rich in signal detail, but it is not directly actionable by mitigation decision logic. The characterization function therefore transforms the signal data into structured interference understanding. That structured interference understanding identifies what is interfering, where the interference lies in spectrum, and how the interference relates to operation of the 5G cell. That output can then support selection of a mitigation technique, including a mitigation technique based on spectrum understanding.

L0 1112 expands Interference Characterization and Classification 1108 into internal operations that carry the event-associated capture through segmentation, feature extraction, characterization, and report generation. External RF Sensor OR eCPRI Decoder 1114 provides Recovered I/Q Data to Collect I/Q Data 1118, and Interference and Anomaly Detection 1116 provides an Interference Event Notification to Collect I/Q Data 1118. Collect I/Q Data 1118 produces an I/Q Data Capture, which is then provided to Segment Scene 1122. Segment Scene 1122 outputs I/Q Segments and Segment Metadata. Compute Features on Segments 1126 receives the I/Q Segments and outputs Features. Characterize Segments 1128 receives the Features and the Segment Metadata and produces Interference Characterization. Package 1124 receives the Interference Characterization and generates the Interference Characterization Report for Mitigation System 1120.

In that internal flow, collection is tied to the detected event so that the captured data matches the operating condition that triggered analysis. Collect I/Q Data 1118 associates the detected event with a corresponding set of I/Q samples. In some embodiments, Collect I/Q Data 1118 acquires or receives recovered I/Q data through a common internal job interface even when the source of that data changes across deployments. The common internal interface allows the rest of the characterization pipeline to operate on a consistent internal representation of capture data and event context. As a result, the later segmentation, feature computation, characterization, and packaging stages can remain substantially unchanged even when the front-end acquisition path differs from one system to another. This modularity supports deployment on systems that expose mirrored fronthaul traffic, decoded fronthaul data, packet capture data, or direct radio-frequency sensor captures.

Because the Interference Event Notification is supplied directly to Collect I/Q Data 1118, collection can be performed in response to a detected condition rather than as an untargeted capture process. The event context may identify the cell under analysis, the operating band, and a time relation for the detected condition. That context helps tie the I/Q Data Capture to the same operating conditions reflected in the triggering operational data. This relationship is useful when the system is evaluating interference onset on a short timescale and then initiating characterization for mitigation of the affected cell.

After capture, the represented radio-frequency scene is broken into smaller portions so that later analysis can remain localized while still preserving scene context. Segment Scene 1122 processes the I/Q Data Capture to divide the represented radio-frequency scene into smaller portions for analysis. Its output includes I/Q Segments and Segment Metadata. The I/Q Segments preserve portions of the recovered signal data for localized analysis. The Segment Metadata preserves context for those portions, including information that relates each segment back to its place within the captured scene. By maintaining that metadata, later characterization can account not only for computed signal features, but also for where and how a given segment appeared within the overall capture. This staged approach supports reusable processing across multiple interference types, including situations in which an interfering signal overlaps a 5G signal.

Feature generation can then proceed on the segmented scene without collapsing the pipeline into a single monolithic analyzer. Compute Features on Segments 1126 derives Features from the I/Q Segments. The Features represent signal properties that permit later characterization of the segmented scene. In some embodiments, the Features capture spectral characteristics of a segment. In some embodiments, the Features capture characteristics that help distinguish different classes of interference represented in the recovered I/Q data. Separating feature computation from characterization allows the subsystem to reuse the same segment-level feature generation stage across different classification tasks and across different deployment topologies. That separation also supports implementations in which the characterization pipeline is organized as distinct internal services rather than as one monolithic analyzer.

Using both measured signal content and scene context, the pipeline then determines what kind of interference is present and how it relates to the affected 5G cell. Characterize Segments 1128 receives both the Features generated by Compute Features on Segments 1126 and the Segment Metadata generated by Segment Scene 1122. Characterize Segments 1128 then produces Interference Characterization for the captured scene. In some embodiments, it determines one or more spectral characteristics of an interfering signal, including a center frequency, a bandwidth, a spectral location, a modulation characteristic, a signal type, or a direction of arrival. In some embodiments, it classifies interference represented in the recovered I/Q data as narrowband interference, broadband interference, or interference from another 5G cell. In some embodiments, it identifies signal-on-signal interference in which an interfering signal overlaps a 5G signal associated with the affected 5G cell. Using both Features and Segment Metadata allows characterization to depend on measured segment content and on the segment's relation to the captured radio-frequency scene.

That internal characterization is then converted into a structured output that downstream mitigation logic can consume without direct access to raw capture artifacts. Package 1124 receives the Interference Characterization from Characterize Segments 1128 and packages that information into the Interference Characterization Report. The report provides a structured output for Mitigation System 1120. In some embodiments, the report identifies a frequency location of an interfering signal within spectrum, a bandwidth of the interfering signal, and a modulation characteristic of the interfering signal. In some embodiments, the report also identifies whether the interference overlaps a 5G signal. This packaging step therefore converts internal characterization outputs into a form that downstream decision logic can consume without needing direct access to raw I/Q data or to intermediate segment-level processing artifacts.

With that report available, mitigation can be selected for the affected 5G cell based on spectrum-aware understanding of the interference condition. Mitigation System 1120 can use the Interference Characterization Report as an input to selecting a mitigation command for the affected 5G cell. In some embodiments, the report supports a decision to change an operating channel. In some embodiments, the report supports dynamic bandwidth adaptation when interference affects an edge portion of the operating bandwidth. More generally, the report gives the mitigation logic spectrum understanding that can be combined with configuration information for the 5G cell to select an appropriate reconfiguration action. The figure thus supports the broader architecture in which characterization informs a later decision and translation path that issues deployment-compatible control actions to the radio access network.

The same functional flow may be implemented with different internal boundaries and in different deployment environments while preserving the operative dataflow shown in FIG. 11. The operations shown in L0 1112 may be implemented with different granularity while preserving the same functional flow shown in the figure. In some embodiments, Collect I/Q Data 1118, Segment Scene 1122, Compute Features on Segments 1126, Characterize Segments 1128, and Package 1124 are implemented as separate microservices, containers, threads, libraries, or co-located modules within a single executable. In some embodiments, the subsystem processes recovered I/Q data through a common internal job interface. In some embodiments, characterization is performed synchronously. In some embodiments, characterization is performed asynchronously, including queue-based, file-based, or application programming interface based exchange of I/Q data, metadata, intermediate results, and reports. These implementation choices allow the figure to cover a modular service grouping without requiring a fixed service boundary arrangement.

FIG. 11 may represent a characterization subsystem that is deployed on-premises, at an edge location, in a cloud environment, or in a hybrid edge cloud architecture. In some embodiments, a near-real-time detection component triggers the characterization flow, while a non-real-time component carries out the characterization processing itself. In some embodiments, edge units run as containers and communicate securely with a control plane. In some embodiments, access to an application programming interface associated with characterization processing is authenticated using per-user application programming interface keys, and that access is logged. In some embodiments, job-level logs and processing metrics are exposed to provide visibility into asynchronous I/Q processing. These deployment variations do not alter the operative dataflow shown in FIG. 11. Within that dataflow, event-associated recovered I/Q data is collected, segmented, analyzed, characterized, and packaged into an Interference Characterization Report for downstream mitigation use.

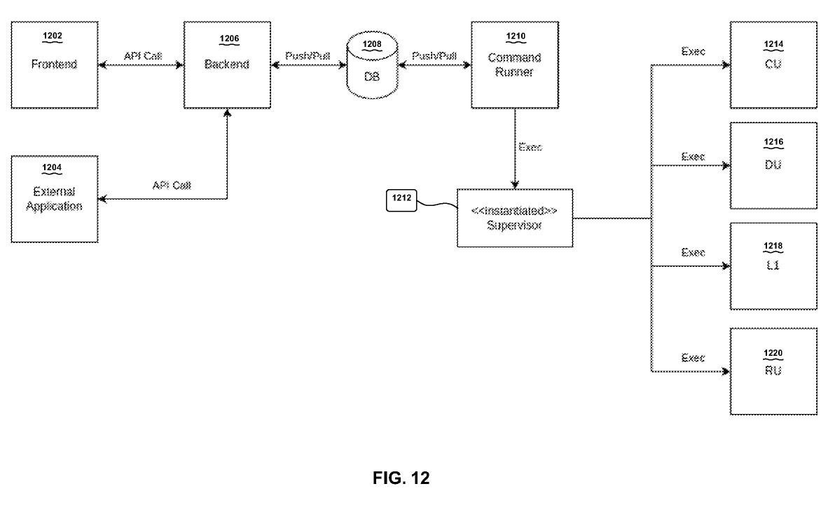

FIG. 12 illustrates a management-plane command execution architecture for staging and coordinating reconfiguration of radio access network components, according to some aspects of the present disclosure.

FIG. External Application 1204 may be an internal automation component that issues a reconfiguration request after interference has been detected and a mitigation action has been selected. In this way, Backend 1206 can receive the same execution path from both human-initiated actions and machine-generated mitigation requests through API Call interactions with Frontend 1202 and External Application 1204.

Once a request is received, Backend 1206 serves as a common management-plane entry point for reconfiguration of the 5G cell. The request may represent a vendor-independent mitigation decision that has been derived from interference processing performed elsewhere in the resilient cell workflow. That upstream processing may include receipt of key performance metric reports and normalization of the reports into normalized key performance metric data structures. The normalized key performance metric data structures may be organized by subscription identifier, and relevant distributed-unit features may be extracted to support generation of an interference event notification. Upstream processing may also include recovery of in-phase and quadrature data, segmentation of a radio-frequency scene into in-phase and quadrature segments and segment metadata, feature extraction from the resulting segments, and generation of an interference characterization report that identifies one or more spectral characteristics of an interfering signal. Backend 1206 allows those detection and characterization outputs to be converted into a controlled execution request without requiring the upstream services to directly manipulate radio access network processes.

Because interference detection may occur on a faster timescale than execution of a full cell reconfiguration, Backend 1206 can decouple decision generation from command execution. A mitigation request received from External Application 1204 may therefore identify a selected action, while the lower-level execution details are handled through the management-plane path shown in the figure. The selected action may correspond to a change in operating bandwidth, channel, power setting, beam-related setting, scheduling setting, resource allocation setting, or another cell parameter chosen in response to an interference characterization result. This separation helps preserve interoperability across differing radio access network implementations because the requesting application can issue a standardized internal call while Backend 1206 and downstream components handle deployment-specific execution behavior.

Before the requested mitigation is applied to the running radio stack, command information may be staged through DB 1208 using a push/pull interface with Backend 1206. DB 1208 may store staged commands, command state, execution records, configuration information, and process-state information associated with the reconfiguration workflow. By persisting command information in DB 1208, the system can queue a requested mitigation action before the action is applied. The stored information may also preserve a record of the originating request, the requested target configuration, and the observed execution status so that subsequent logic can determine whether a selected mitigation action was carried out successfully.

In some embodiments, the information associated with a staged command can include a reconfiguration request derived from interference-aware decision logic and contextual data used to prepare that request for execution. That contextual data may reflect current cell configuration information, interference event information, or characterization outputs that describe a frequency location, bandwidth, modulation characteristic, or overlap condition of an interfering signal. A history of normalized key performance metrics may also be captured in response to an interference event and stored for later analysis or model refinement. Although that history need not be consumed directly by the command path in every implementation, the architecture supports retaining it as part of the broader resilient cell workflow.

After a command has been staged, Command Runner 1210 may exchange data with DB 1208 through a further push/pull interface and may retrieve staged commands for execution. Command Runner 1210 may interpret the command records and initiate execution of the corresponding reconfiguration procedure. This arrangement separates acceptance of a request from performance of the requested process control operations. That separation is useful when an interference condition is detected quickly from key performance metrics, while the selected mitigation requires a coordinated sequence of lower-level actions across multiple radio access network components.

Execution may then proceed through Supervisor 1212, which the figure shows as an instantiated component invoked by Command Runner 1210. Supervisor 1212 may carry out a command pattern or similar execution procedure for the target deployment. In operation, Supervisor 1212 may coordinate process startup, process shutdown, reset handling, and configuration rewrite actions needed to move the cell from a current configuration to a mitigation configuration. The instantiated presentation of Supervisor 1212 reflects that the supervisory logic may be created or invoked for a particular execution request rather than being limited to a permanently dedicated process in all embodiments.

During that supervisory phase, execution control may be issued to CU 1214, DU 1216, L1 1218, and RU 1220. CU 1214 represents a centralized unit. DU 1216 represents a distributed unit. L1 1218 represents a Layer 1 process. RU 1220 represents a radio unit. A selected mitigation action may require coordinated changes across one or more of these components, and Supervisor 1212 can apply those changes in a defined order so that the reconfiguration is consistent with the deployed 5G implementation.

This coordinated execution path is particularly useful when the mitigation decision is based on characterization of an interfering signal within the operating band of the 5G cell. For instance, an upstream interference characterization report may indicate whether the interfering signal occupies a center portion or an edge portion of the operating bandwidth. The report may also indicate whether the interference is narrowband or broadband, or whether the interference overlaps another 5G signal. Decision logic may use that information to select a mitigation command. Backend 1206, Command Runner 1210, and Supervisor 1212 then translate that selected command into concrete deployment actions on CU 1214, DU 1216, L1 1218, and RU 1220.

In some embodiments, Backend 1206 functions as a radio access technology provider wrapper or as part of a gNodeB management service that exposes a standardized application programming interface to higher-level decision logic. In that arrangement, a mitigation command generated as a standardized internal call can be translated into vendor-specific or deployment-specific control actions. Those actions may include updating configuration files, stopping a cell, starting a cell, resetting one or more processes, or otherwise applying a revised radio configuration through the interfaces available in the deployment. This approach is useful when a standardized radio access network reconfiguration interface is unavailable, incomplete, or not suitable for the requested mitigation.

After a command has been staged or executed, the architecture of FIG. 12 also supports operational feedback. Process state information and command status may be stored in DB 1208, exposed by Backend 1206, displayed through Frontend 1202, or returned to External Application 1204. A requesting application can therefore use the observed state of CU 1214, DU 1216, L1 1218, and RU 1220 as input to a subsequent mitigation decision. This closed-loop behavior helps the resilient cell workflow move from detection to characterization, then to mitigation, and then to verification of the resulting operating state.

Although FIG. 12 depicts separate blocks for Frontend 1202, External Application 1204, Backend 1206, DB 1208, Command Runner 1210, and Supervisor 1212, the illustrated partitioning is architectural rather than limiting. In some embodiments, one or more of those functions may be combined into a single service, container, or processing pipeline. Even in those arrangements, the figure conveys the same functional relationship: a mitigation-related request is received through a management-plane interface, staged through persistent command handling, executed through supervisory control, and applied to the radio access network components represented by CU 1214, DU 1216, L1 1218, and RU 1220.

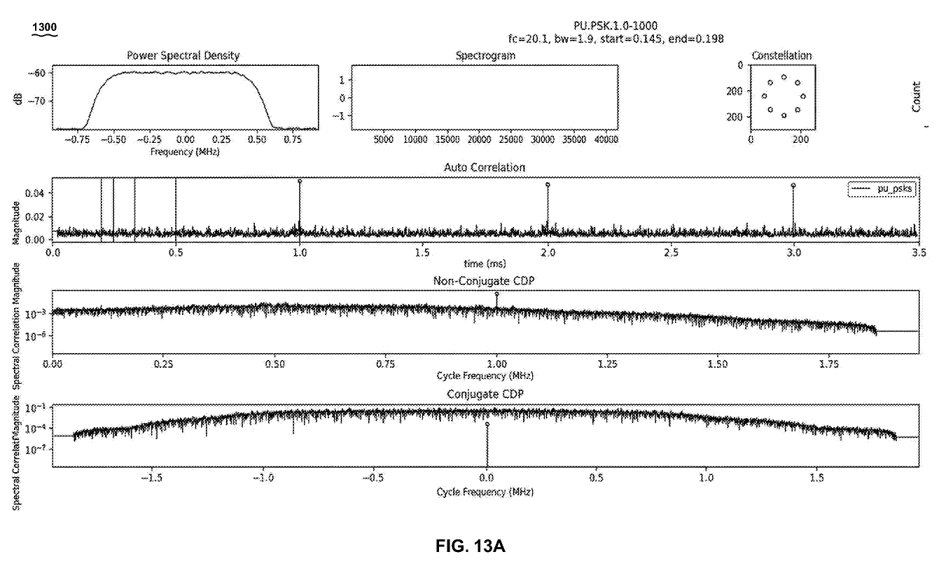

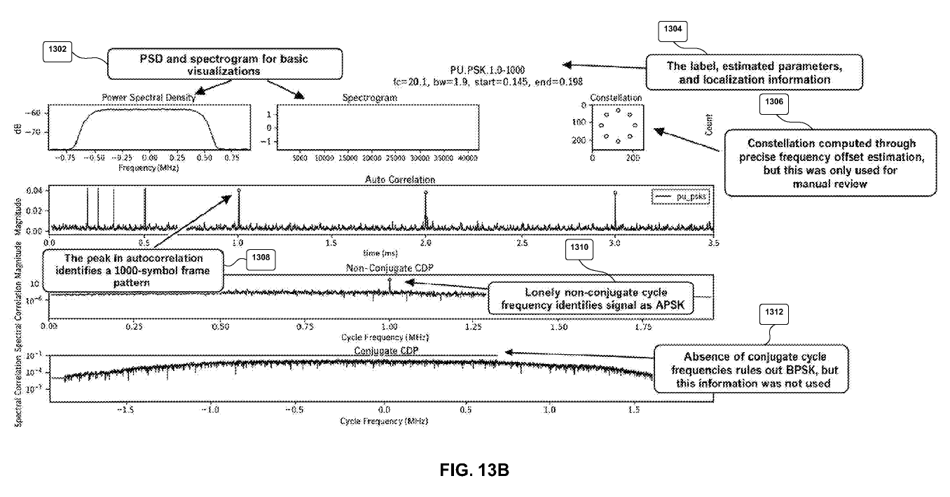

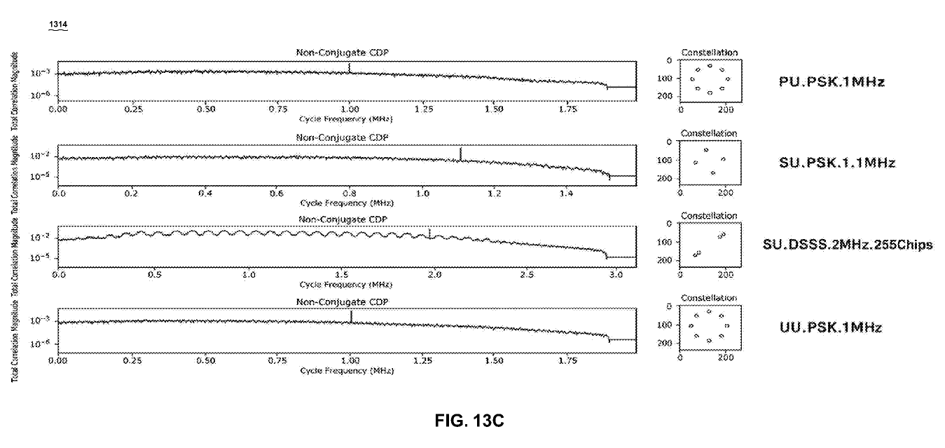

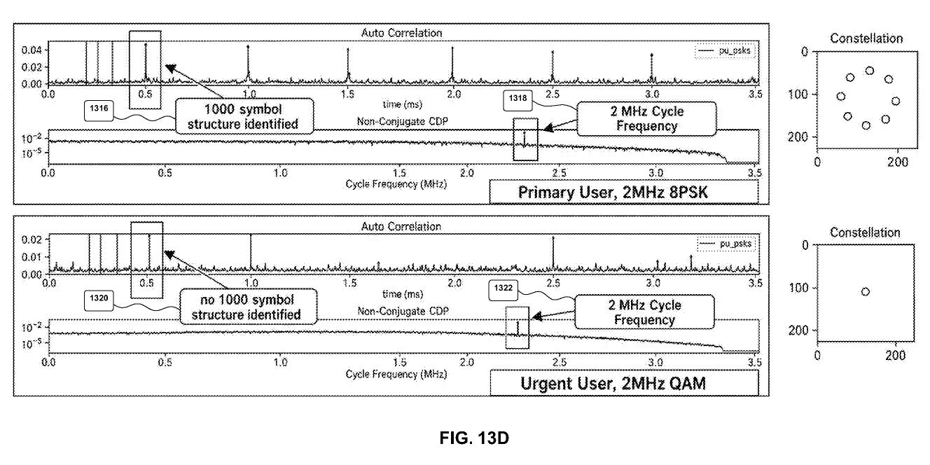

FIGS. 13A-13D illustrates signal-analysis views used by an interference characterization process to estimate spectral, temporal, and modulation-related properties of interfering signals, according to some aspects of the present disclosure.

When a KPM-driven interference event notification indicates that further analysis is warranted, an interference characterization and classification component may process recovered or collected in-phase and quadrature data associated with radio-frequency activity in an operating band of a 5G cell. The in-phase and quadrature data may be obtained from decoded open fronthaul traffic, packet capture data, an external radio-frequency sensor, or another available signal source, depending on the deployment. From that data, the component may generate analysis output 1300, allowing the same signal scene to be represented in multiple coordinated views rather than by a single energy measurement. That multi-view representation allows the characterization process to derive a richer set of signal properties before generating an interference characterization report.

In FIG. 13A, analysis output 1300 includes a Power Spectral Density view, a Spectrogram view, a Constellation view, an Auto Correlation view, a Non-Conjugate CDP view, and a Conjugate CDP view. These views are derived from the same underlying in-phase and quadrature samples, and each view highlights a different feature domain. The Power Spectral Density view indicates how energy is distributed across frequency within the observed band, while the Spectrogram view indicates how that energy varies over time. The Constellation view reflects clustering behavior in the in-phase and quadrature plane after signal recovery. The Auto Correlation view exposes repeated timing structure. The Non-Conjugate CDP view and the Conjugate CDP view expose cyclic spectral behavior that can help distinguish between different signal types or modulation behaviors.

By examining those coordinated views together, the characterization component may determine how an interfering signal overlaps the spectrum of the 5G cell. For example, the interfering signal may be narrowband or broadband. It may be centered within the cell bandwidth, located near an edge of the cell bandwidth, or overlapping another signal already present in the band. The characterization component may also derive a center frequency, bandwidth, spectral location, and modulation-related indication from these views. In some embodiments, the characterization component further determines whether the observed signal exhibits repeated temporal structure, signal-on-signal overlap, or a cyclic feature that is useful for distinguishing one class of interferer from another. Those outputs may then be packaged into the interference characterization report for use by mitigation decision logic.

The illustrated title data in FIG. 13A further shows that the characterization output may include a label and estimated parameters associated with the analyzed signal segment. This reflects segment-based processing in which the characterization component may operate on individual in-phase and quadrature segments rather than only on an entire capture. A radio-frequency scene may therefore be segmented. Segment metadata may be produced, features may be computed for the resulting segments, and one or more segments may then be characterized to produce reportable results. In some embodiments, that processing is performed as part of a single executable pipeline. In some embodiments, it is performed across multiple services or processing stages.

FIG. 13B shows how selected regions of analysis output 1300 may be interpreted as part of that characterization process. Annotation 1302 identifies the PSD and spectrogram as basic visualizations. These views can provide an initial understanding of occupied spectrum and temporal occupancy. They can also indicate whether a detected emitter is localized in frequency or spread across a wider portion of the band. In practice, the same views may support localization of the interfering signal within the observed spectrum so that later mitigation logic can determine whether the interferer affects a center portion of the cell bandwidth or an edge portion of the cell bandwidth. Annotation 1304 identifies the label, estimated parameters, and localization information shown with the analyzed signal. This information may be included in the interference characterization report that is delivered to downstream logic. In some embodiments, the reported parameters include a frequency location within the observed spectrum, an occupied bandwidth, and a modulation-related characteristic. When available from the sensing arrangement, the report may also include localization information or another indicator that helps identify the interfering source or its spatial relationship to the serving cell.

The characterization pipeline may compute additional features even when a particular run does not use every feature for automated classification. Annotation 1306 explains that the depicted Constellation view was computed through precise frequency offset estimation and was used for manual review in the illustrated analysis. Some computed features therefore may be used directly for classification, while others may be retained as supporting evidence, for confirmation, or for later review. In that way, the characterization component may preserve technically useful context without requiring every available feature to drive the final classification decision.

Coordinated views may also support interpretation of temporal and cyclic-domain features to refine the characterization result. Annotation 1308 points to a peak in the Auto Correlation view and indicates a symbol-frame pattern. A repeated temporal structure of that kind may help distinguish among signals that occupy a similar bandwidth but differ in frame organization or symbol timing. Annotation 1310 points to a feature in the Non-Conjugate CDP view and indicates that a lonely non-conjugate cycle frequency identifies the signal as APSK in the illustrated analysis. Annotation 1312 points to the Conjugate CDP view and indicates that the absence of conjugate cycle frequencies rules out BPSK in the illustrated analysis, while also noting that this information was not used in that particular review. Taken together, these annotations show that characterization is not limited to energy detection. Instead, the characterization component may combine spectral features, temporal features, constellation-derived information, and cyclic spectral features to produce a richer report that is more useful to later mitigation logic.

FIG. 13C extends that approach by showing comparative characterization view 1314, in which several labeled signal classes are arranged in corresponding pairs of Non-Conjugate CDP traces and Constellation views. The displayed labels include PU.PSK.1MHz, SU.PSK.1.1MHz, SU.DSSS.2MHz.255Chips, and UU.PSK.1MHz. This arrangement illustrates that different signal classes may produce different cyclic signatures and different in-phase and quadrature clustering patterns even when they occupy generally similar spectrum. The characterization component can therefore compare computed features for an observed segment against known class patterns, or otherwise use those features as inputs to a classifier that distinguishes between candidate interference types.

That comparative view also shows why segment metadata and per-segment feature computation may be beneficial. A radio-frequency capture may include more than one signal condition over time, and useful classification often depends on isolating the relevant segment before deriving features. Once segmented, each segment can be processed to compute cyclic-domain and constellation-domain features, and the resulting features can be associated with the segment metadata when generating the interference characterization report. In some embodiments, the characterization and classification operation is performed on-premises. In some embodiments, it is performed in a cloud environment. In some embodiments, the detection path operates at edge compute while characterization and classification operate in a hybrid edge-cloud deployment, with substantially similar feature extraction and report generation behavior across those deployments.

FIG. 13D further illustrates how signals having different temporal and modulation-related structure may share some characteristics while differing in others. The upper analysis is labeled Primary User, 2MHz 8PSK. Annotation 1316 identifies a 1000 symbol structure in the Auto Correlation view, and annotation 1318 identifies a 2 MHz cycle frequency in the Non-Conjugate CDP view. The lower analysis is labeled Urgent User, 2MHz QAM. Annotation 1320 indicates that no 1000 symbol structure is identified in the lower Auto Correlation view, while annotation 1322 identifies a 2 MHz cycle frequency in the lower Non-Conjugate CDP view. These paired examples show that a common bandwidth-related or cycle-frequency-related feature may appear in more than one signal class, while temporal structure and constellation behavior still differ in a way that remains useful for classification.

For that reason, the interference characterization and classification component may generate the interference characterization report from a combination of feature types rather than from a single feature source. The report may therefore indicate not only spectral occupancy, but also a temporal pattern, a cyclic feature, a modulation-related characteristic, or an overlap condition involving another 5G signal. In a resilient 5G workflow, that characterization result may be provided to a mitigation system after KPM-based detection has identified an interference condition and triggered in-phase and quadrature acquisition. The characterization report can then be consumed by decision logic that selects a mitigation command based on the identified spectral characteristics of the interfering signal and configuration information for the affected 5G cell. In some embodiments, characterization output is generated through direct service interaction. In some embodiments, it is generated asynchronously through a job application programming interface, queued processing, or file-based exchange. In some embodiments, normalized KPM history, event context, segment data, extracted features, and characterization outputs are persisted in one or more data stores so that the detection stage and the characterization stage can remain coordinated even when implemented as separate services or in separate execution environments.

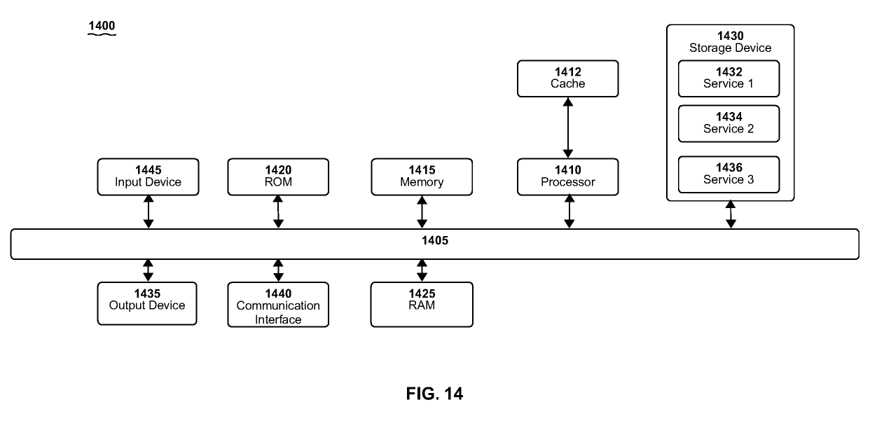

FIG. 14 is a diagram illustrating a computing system according to some aspects of the present disclosure.

In particular, FIG. 14 illustrates an example of computing system 1400, which may be, for example, any computing device or components of example systems described above. Components of computing system 1400 may be in communication with each other using connection 1405. Connection 1405 may be a physical connection using a bus, or a direct connection into processor 1410, such as in a chipset architecture. Connection 1405 may also be a virtual connection, networked connection, or logical connection.

In some embodiments, computing system 1400 is a distributed system in which the functions described in this disclosure may be distributed within a datacenter, multiple datacenters, a peer network, etc. In some embodiments, one or more of the described system components represents many such components each performing some or all of the function for which the component is described. In some embodiments, the components may be physical or virtual devices.

An example computing system 1400 includes a processor 1410 and connection 1405 that communicatively couples various system components including system memory 1415, such as ROM 1420 and RAM 1425 to processor 1410. Computing system 1400 may include a cache 1412 of high-speed memory connected directly with, in close proximity to, or integrated as part of processor 1410.

The processor 1410 may include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which may represent any number of input mechanisms, such as a microphone for speech, a touch-sensitive screen for gesture or graphical input, keyboard, mouse, motion input, speech, etc. Computing system 1400 may also include output device 1435, which may be one or more of a number of output mechanisms. In some instances, multimodal systems may enable a user to provide multiple types of input/output to communicate with computing system 1400.

Computing system 1400 may include communications interface 1440, which may generally govern and manage the user input and system output. The communications interface may perform or facilitate receipt and/or transmission of wired or wireless communications using wired and/or wireless transceivers, including those making use of an audio jack/plug, a microphone jack/plug, a universal serial bus (USB) port/plug, an AppleTM LightningTM port/plug, an Ethernet port/plug, a fiber optic port/plug, a proprietary wired port/plug, 3G, 4G, 5G and/or other cellular data network wireless signal transfer, a BluetoothTM wireless signal transfer, a BluetoothTM low energy (BLE) wireless signal transfer, an IBEACONTM wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, WLAN signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 may be a non-volatile and/or non-transitory and/or computer-readable memory device and may be a hard disk or other types of computer-readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, an EMV chip, a subscriber identity module (SIM) card, a mini/micro/nano/pico SIM card, another integrated circuit (IC) chip/card, RAM, static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASH EPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof.

The storage device 1430 may include software services, servers, services, etc., that when the code that defines such software is executed by the processor 1410, it causes the system to perform a function. In some embodiments, a hardware service that performs a particular function may include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

In some embodiments, the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any one of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. One or more processor(s) may perform the necessary tasks. Examples of form factors include laptops, smartphones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, perform one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (<) and greater than (>) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference is made to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

### ASPECTS

Aspects of the disclosure include:

Aspect 1: A computer-implemented method for mitigating interference in a 5G wireless communication system, the method including: receiving, by an interference detection service, key performance metric (KPM) reports associated with operation of a 5G cell; processing the KPM reports to detect an interference condition affecting the 5G cell; in response to detecting the interference condition, initiating acquisition of in-phase and quadrature (I/Q) data associated with radio-frequency signals in an operating band of the 5G cell; processing the I/Q data to generate an interference characterization report indicating at least one spectral characteristic of an interfering signal; determining a mitigation command based on the interference characterization report and configuration information for the 5G cell; translating, using a 5G radio access translation scheme, the mitigation command into one or more reconfiguration commands compatible with a 5G radio access network implementation; and causing the 5G radio access network implementation to reconfigure the 5G cell according to the one or more reconfiguration commands to reduce an effect of the interfering signal.

Aspect 2: The method of aspect 1, wherein processing the KPM reports comprises normalizing the KPM reports into normalized KPM data structures, storing the normalized KPM data structures, organizing the normalized KPM data structures by subscription identifier, discarding centralized-unit data frames, cleaning distributed-unit data frames, extracting relevant distributed-unit features, and evaluating the relevant distributed-unit features to generate an interference event notification.

Aspect 3: The method of any one of aspects 1-2, wherein detecting the interference condition comprises applying a neural network or other inference engine trained using KPM data corresponding to non-interference operating conditions and interference operating conditions.

Aspect 4: The method of any one of aspects 1-3, wherein initiating acquisition of the I/Q data comprises acquiring the I/Q data from at least one of a mirrored Open Front Haul interface, an evolved Common Public Radio Interface (eCPRI) decoder, packet captures of Open Front Haul traffic, or an external software-defined radio.

Aspect 5: The method of any one of aspects 1-4, wherein the I/Q data is recovered by decoding eCPRI traffic from the mirrored Open Front Haul interface or from the packet captures of Open Front Haul traffic.

Aspect 6: The method of any one of aspects 1-5, wherein the external software-defined radio is controlled by an I/Q collector service that configures at least one of a sampling rate, tuning frequency, or capture parameter for the external software-defined radio.

Aspect 7: The method of any one of aspects 1-6, wherein processing the I/Q data comprises segmenting a radio-frequency scene represented by the I/Q data, computing features for resulting I/Q segments, and characterizing the resulting I/Q segments to generate the interference characterization report.

Aspect 8: The method of any one of aspects 1-7, wherein the interference characterization report identifies at least one of a center frequency, bandwidth, spectral location, modulation type, signal type, direction of arrival, narrowband interference, broadband interference, or another 5G signal overlapping the 5G cell.

Aspect 9: The method of any one of aspects 1-8, wherein determining the mitigation command comprises determining whether the interfering signal overlaps a center portion or an edge portion of an operating bandwidth of the 5G cell and determining whether alternate spectrum is available for use by the 5G cell.

Aspect 10: The method of any one of aspects 1-9, wherein the mitigation command comprises at least one of dynamic bandwidth adaptation, dynamic spectrum access, dynamic channel assignment, dynamic power adaptation, beamforming, beam nulling, scheduling adjustment, resource allocation adjustment, or changing an operating channel of the 5G cell.

Aspect 11: The method of any one of aspects 1-10, wherein translating the mitigation command comprises translating a vendor-independent command generated by the decision logic into a vendor-specific or deployment-specific command for a gNB manager, RAN intelligent controller (RIC), rApp, xApp, element management system, or proprietary 5G radio access network interface.

Aspect 12: The method of any one of aspects 1-11, wherein causing the 5G radio access network implementation to reconfigure the 5G cell comprises staging a coordinated reconfiguration using a command queue, supervisor, or management-plane component that stops, starts, resets, or rewrites configuration files for one or more of a radio unit, distributed unit, centralized unit, Layer 1 process, or gNB process.

Aspect 13: A system for mitigating interference in a 5G wireless communication system, the system including: one or more processors; and one or more non-transitory computer-readable storage media storing instructions that, when executed by the one or more processors, cause the system to: receive, by an interference detection service, key performance metric (KPM) reports associated with operation of a 5G cell; process the KPM reports to detect an interference condition affecting the 5G cell; in response to detecting the interference condition, initiate acquisition of in-phase and quadrature (I/Q) data associated with radio-frequency signals in an operating band of the 5G cell; process the I/Q data to generate an interference characterization report indicating at least one spectral characteristic of an interfering signal; determine a mitigation command based on the interference characterization report and configuration information for the 5G cell; translate, by a 5G radio access translation scheme, the mitigation command into one or more reconfiguration commands compatible with a 5G radio access network implementation; and cause the 5G radio access network implementation to reconfigure the 5G cell according to the one or more reconfiguration commands to reduce an effect of the interfering signal.

Aspect 14: The system of aspect 13, wherein processing the KPM reports comprises normalizing the KPM reports into normalized KPM data structures, storing the normalized KPM data structures, organizing the normalized KPM data structures by subscription identifier, discarding centralized-unit data frames, cleaning distributed-unit data frames, extracting relevant distributed-unit features, and evaluating the relevant distributed-unit features to generate an interference event notification.

Aspect 15: The system of any one of aspects 13-14, wherein detecting the interference condition comprises applying a neural network or other inference engine trained using KPM data corresponding to non-interference operating conditions and interference operating conditions.

Aspect 16: The system of any one of aspects 13-15, wherein initiating acquisition of the I/Q data comprises acquiring the I/Q data from at least one of a mirrored Open Front Haul interface, an evolved Common Public Radio Interface (eCPRI) decoder, packet captures of Open Front Haul traffic, or an external software-defined radio.

Aspect 17: The system of any one of aspects 13-16, wherein processing the I/Q data comprises segmenting a radio-frequency scene represented by the I/Q data, computing features for resulting I/Q segments, and characterizing the resulting I/Q segments to generate the interference characterization report.

What is claimed is:

1. A computer-implemented method for mitigating interference in a 5G wireless communication system, the computer-implemented method comprising:
receiving, by an interference detection service, key performance metric reports (KPM reports) associated with operation of a 5G cell;
processing the KPM reports to detect an interference condition affecting the 5G cell;
in response to detecting the interference condition, initiating acquisition of in-phase and quadrature data (I/Q data) associated with radio-frequency signals in an operating band of the 5G cell;
processing the I/Q data to generate an interference characterization report indicating at least one spectral characteristic of an interfering signal;
determining a mitigation command based on the interference characterization report and configuration information for the 5G cell;
translating, using a 5G radio access translation scheme, the mitigation command into one or more reconfiguration commands compatible with a 5G radio access network implementation; and
causing the 5G radio access network implementation to reconfigure the 5G cell according to the one or more reconfiguration commands to reduce an effect of the interfering signal.

2. The computer-implemented method of claim 1, wherein processing the KPM reports comprises normalizing the KPM reports into normalized KPM data structures, storing the normalized KPM data structures, organizing the normalized KPM data structures by subscription identifier, discarding centralized-unit data frames, cleaning distributed-unit data frames, extracting relevant distributed-unit features, and evaluating the relevant distributed-unit features to generate an interference event notification.

3. The computer-implemented method of claim 1, wherein detecting the interference condition comprises applying a neural network or other inference engine trained using KPM data corresponding to non-interference operating conditions and interference operating conditions.

4. The computer-implemented method of claim 1, wherein initiating acquisition of the I/Q data comprises acquiring the I/Q data from at least one of a mirrored Open Front Haul interface, an evolved Common Public Radio Interface (eCPRI) decoder, packet captures of Open Front Haul traffic, or an external software-defined radio.

5. The computer-implemented method of claim 4, wherein the I/Q data is recovered by decoding eCPRI traffic from the mirrored Open Front Haul interface or from the packet captures of Open Front Haul traffic.

6. The computer-implemented method of claim 4, wherein the external software-defined radio is controlled by an I/Q collector service that configures at least one of a sampling rate, tuning frequency, or capture parameter for the external software-defined radio.

7. The computer-implemented method of claim 1, wherein processing the I/Q data comprises segmenting a radio-frequency scene represented by the I/Q data, computing features for resulting I/Q segments, and characterizing the resulting I/Q segments to generate the interference characterization report.

8. The computer-implemented method of claim 1, wherein the interference characterization report identifies at least one of a center frequency, bandwidth, spectral location, modulation type, signal type, direction of arrival, narrowband interference, broadband interference, or another 5G signal overlapping the 5G cell.

9. The computer-implemented method of claim 1, wherein determining the mitigation command comprises determining whether the interfering signal overlaps a center portion or an edge portion of an operating bandwidth of the 5G cell and determining whether alternate spectrum is available for use by the 5G cell.

10. The computer-implemented method of claim 1, wherein the mitigation command comprises at least one of dynamic bandwidth adaptation, dynamic spectrum access, dynamic channel assignment, dynamic power adaptation, beamforming, beam nulling, scheduling adjustment, resource allocation adjustment, or changing an operating channel of the 5G cell.

11. The computer-implemented method of claim 1, wherein translating the mitigation command comprises translating a vendor-independent command generated into a vendor-specific or deployment-specific command for a gNB manager, RAN intelligent controller (RIC), rApp, xApp, element management system, or proprietary 5G radio access network interface.

12. The computer-implemented method of claim 1, wherein causing the 5G radio access network implementation to reconfigure the 5G cell comprises staging a coordinated reconfiguration using a command queue, supervisor, or management-plane component that stops, starts, resets, or rewrites configuration files for one or more of a radio unit, distributed unit, centralized unit, Layer 1 process, or gNB process.

13. A system for mitigating interference in a 5G wireless communication system, the system comprising:
one or more processors; and
one or more non-transitory computer-readable storage media storing instructions that, when executed by the one or more processors, cause the system to:
receive, by an interference detection service, key performance metric reports (KPM reports) associated with operation of a 5G cell;
process the KPM reports to detect an interference condition affecting the 5G cell;
in response to detecting the interference condition, initiate acquisition of in-phase and quadrature data (I/Q data) associated with radio-frequency signals in an operating band of the 5G cell;
process the I/Q data to generate an interference characterization report indicating at least one spectral characteristic of an interfering signal;
determine a mitigation command based on the interference characterization report and configuration information for the 5G cell;
translate, by a 5G radio access translation scheme, the mitigation command into one or more reconfiguration commands compatible with a 5G radio access network implementation; and
cause the 5G radio access network implementation to reconfigure the 5G cell according to the one or more reconfiguration commands to reduce an effect of the interfering signal.

14. The system of claim 13, wherein processing the KPM reports comprises normalizing the KPM reports into normalized KPM data structures, storing the normalized KPM data structures, organizing the normalized KPM data structures by subscription identifier, discarding centralized-unit data frames, cleaning distributed-unit data frames, extracting relevant distributed-unit features, and evaluating the relevant distributed-unit features to generate an interference event notification.

15. The system of claim 13, wherein detecting the interference condition comprises applying a neural network or other inference engine trained using KPM data corresponding to non-interference operating conditions and interference operating conditions.

16. The system of claim 13, wherein initiating acquisition of the I/Q data comprises acquiring the I/Q data from at least one of a mirrored Open Front Haul interface, an evolved Common Public Radio Interface (eCPRI) decoder, packet captures of Open Front Haul traffic, or an external software-defined radio.

17. The system of claim 13, wherein processing the I/Q data comprises segmenting a radio-frequency scene represented by the I/Q data, computing features for resulting I/Q segments, and characterizing the resulting I/Q segments to generate the interference characterization report.

18. A non-transitory computer-readable medium storing instructions that, when executed by one or more processors, cause the one or more processors to perform operations for mitigating interference in a 5G wireless communication system, the operations comprising:
receive, by an interference detection service, key performance metric reports (KPM reports) associated with operation of a 5G cell;
process the KPM reports to detect an interference condition affecting the 5G cell;
in response to detection of the interference condition, initiate acquisition of in-phase and quadrature data (I/Q data) associated with radio-frequency signals in an operating band of the 5G cell;
process the I/Q data to generate an interference characterization report indicating at least one spectral characteristic of an interfering signal;
determine a mitigation command based on the interference characterization report and configuration information for the 5G cell;
translate, using a 5G radio access translation scheme, the mitigation command into one or more reconfiguration commands compatible with a 5G radio access network implementation; and
cause the 5G radio access network implementation to reconfigure the 5G cell according to the one or more reconfiguration commands to reduce an effect of the interfering signal.

19. The non-transitory computer-readable medium of claim 18, wherein the operations for processing the KPM reports comprise normalizing the KPM reports into normalized KPM data structures, storing the normalized KPM data structures, organizing the normalized KPM data structures by subscription identifier, discarding centralized-unit data frames, cleaning distributed-unit data frames, extracting relevant distributed-unit features, and evaluating the relevant distributed-unit features to generate an interference event notification.

20. The non-transitory computer-readable medium of claim 18, wherein the operations for detecting the interference condition comprise applying a neural network or other inference engine trained using KPM data corresponding to non-interference operating conditions and interference operating conditions.
